(19) United States
(12) Patent Application Publication
(10) Pub. No.: US 2026/0306952 A1
(43) Pub. Date: Oct. 8, 2026

(54) METHOD AND APPARATUS FOR CONTROLLING MOVEMENT OF CONTROLLED CHARACTER, DEVICE AND MEDIUM

(71) Applicant: NETEASE (HANGZHOU) NETWORK CO., LTD., Hangzhou, Zhejiang (CN)

(72) Inventors: Hanchang LUO, Hangzhou, Zhejiang (CN); Ye TIAN, Hangzhou, Zhejiang (CN); Chengyi BAI, Hangzhou, Zhejiang (CN)

(73) Assignee: NETEASE (HANGZHOU) NETWORK CO., LTD., Hangzhou, Zhejiang (CN)

(21) Appl. No.: 19/483,286

(22) PCT Filed: Apr. 16, 2024
(86) PCT No.: PCT/CN2024/087862

§ 371 Date: Nov. 11, 2025

(30) Foreign Application Priority Data
May 11, 2023 (CN) 202310542720.X

(51) Int. Cl. A63F 13/56; A63F 13/52

(52) U.S. Cl. CPC A63F 13/56; A63F 13/52; A63F 2300/308

(57) ABSTRACT

A method for controlling a movement of a controlled character includes: activating, in response to an operation on a controlled character, a parkour movement state; wherein a graphical user interface is provided by the electronic device for displaying a virtual scene and the controlled character located in the virtual scene, and the parkour movement state is a state in which the controlled character is controlled, based on a terrain data, to pass through a terrain object; determining, in response to a movement of the controlled character in the virtual scene in the parkour movement state, the terrain object in the virtual scene and a terrain data of the terrain object; and controlling the controlled character to pass through the terrain object with a parkour movement action adapted to the terrain data.

### CROSS REFERENCE TO RELATED APPLICATION

The present application claims the priority of the Chinese Patent Application No. 202310542720.X, titled “METHOD AND APPARATUS FOR CONTROLLING MOVEMENT OF CONTROLLED CHARACTER, DEVICE AND MEDIUM”, filed on May 11, 2023, which is incorporated herein by reference in its entirety.

### TECHNICAL FIELD

The present disclose relates to a technical field of a game, in particular to a method, an apparatus, a device and a medium for controlling movement of a controlled character.

### BACKGROUND

As open-world exploration games, such as those in the martial arts genre, have become popular, the extremely vast terrain poses higher demands on the methods for controlling movement of a controlled character.

In related games, the movement of the controlled character is to be actively controlled by the player and is only processed in a simple and uniform way, which is difficult to adapt to different terrains and results in a slow movement speed, making the exploration of the controlled character in the open world not smooth enough.

### SUMMARY

In view of the above problems, a method, an apparatus, a device and a medium for controlling movement of a controlled character are proposed in order to overcome or at least partially solve the above problems, including the followings.

A method for controlling a movement of a controlled character, wherein a graphical user interface is provided by an electronic terminal, the electronic terminal displays, by the graphical user interface, a virtual scene and a controlled character located in the virtual scene, the method includes: entering, in response to an operation on the controlled character, a parkour movement state; where, the parkour movement state is a state in which the controlled character is controlled, based on a terrain data, to autonomously pass through a terrain object; determining, in response to a movement of the controlled character in the virtual scene in the parkour movement state, a terrain object in the virtual scene and a terrain data of the terrain object; and controlling the controlled character to autonomously pass through terrain object with parkour movement action adapted to the terrain data.

An apparatus for controlling a movement of a controlled character, where a graphical user interface is provided by an electronic terminal, the electronic terminal displays, by the graphical user interface, a virtual scene and a controlled character located in the virtual scene, the apparatus includes: a module for entering a parkour movement state in response to an operation, configured to enter, in response to an operation on the controlled character, a parkour movement state; where, the parkour movement state is a state in which the controlled character is controlled, based on a terrain data, to autonomously pass through a terrain object; a module for determining a terrain object and a terrain data, configured to determine, in response to a movement of the controlled character in the virtual scene in the parkour movement state, a terrain object in the virtual scene and a terrain data of the terrain object; and a module for controlling the terrain object with a parkour, configured to control the controlled character to autonomously pass through the terrain object with a parkour movement action adapted to the terrain data.

An electronic device, including a processor, a memory, and a computer program stored on the memory and capable of running on the processor, when the computer program is executed by the processor, the computer program implements the foregoing method for controlling the movement of the controlled character.

A computer-readable storage medium, where the computer-readable storage medium stores a computer program, and when the computer program is executed by a processor, the processor implements the foregoing method for controlling the movement of the controlled character.

These embodiments of the present disclosure provide following advantages.

In these embodiments of the present disclosure, in response to an operation on the controlled character, a parkour movement state is entered; where, the parkour movement state is a state in which the controlled character is controlled, based on a terrain data, to autonomously pass through a terrain object; in response to a movement of the controlled character in the virtual scene in the parkour movement state, a terrain object in the virtual scene and a terrain data of the terrain object are determined; and the controlled character is controlled to autonomously pass through terrain object with parkour movement action adapted to the terrain data. The controlled character can be controlled to move automatically by adopting the parkour movement action adapted to the terrain data, so that the controlled character can adapt to different terrain conditions and can obtain a faster moving speed, and the smoothness of the controlled character in open world exploration is improved

### BRIEF DESCRIPTION OF THE DRAWINGS

In order to explain the technical solution in the present disclosure more clearly, the drawings in the description of the present disclosure will be briefly introduced below. The drawings in the following description are only some embodiments of the present disclosure. For ordinary skilled in this art, other drawings can be obtained according to these drawings without inventive work.

FIG. 1 is a step flowchart of a method for controlling movement of a controlled character provided by one of these embodiments of the present disclosure.

FIG. 2 is a schematic diagram of a movement scene provided by one of these embodiments of the present disclosure.

FIG. 3 is a step flowchart of another method for controlling movement of a controlled character provided by one of these embodiments of the present disclosure.

FIG. 4a is a schematic diagram of a crossing trajectory provided by one of these embodiments of the present disclosure.

FIG. 4b is a schematic diagram of another crossing trajectory provided by one of these embodiments of the present disclosure.

FIG. 4c is a schematic diagram of a secondary crossing trajectory provided by one of these embodiments of the present disclosure.

FIG. 4d is a schematic diagram of a jump trajectory provided by one of these embodiments of the present disclosure.

FIG. 4e is a schematic diagram of a jump trajectory provided by one of these embodiments of the present disclosure.

FIG. 5 is a step flowchart of another method for controlling movement of a controlled character provided by one of these embodiments of the present disclosure.

FIG. 6a is a schematic diagram of a movement scene provided by one of these embodiments of the present disclosure.

FIG. 6b is a schematic diagram of a capsule provided by one of these embodiments of the present disclosure.

FIG. 6c is a schematic diagram of a movement scene 1 provided by one of these embodiments of the present disclosure.

FIG. 6d is a schematic diagram of a movement scene 2 provided by one of these embodiments of the present disclosure.

FIG. 6e is a schematic diagram of a movement direction fusion provided by one of these embodiments of the present disclosure.

FIG. 6f is a schematic diagram of a virtual camera adjustment provided by one of these embodiments of the present disclosure.

FIG. 7 is a structural block diagram of an apparatus for controlling movement of a controlled character provided by one of these embodiments of the present disclosure.

### DETAILED DESCRIPTION

In order to make the above objects, features and advantages of the present disclosure more obvious and easier to understand, the present disclosure will be further described in detail with reference to the attached drawings and specific embodiments. The described embodiments are a part of these embodiments of the present disclosure, not the whole embodiment. Based on these embodiments of the present disclosure, all other embodiments obtained by those skilled in the art without creative work belong to the protection scope of the present disclosure.

Referring to FIG. 1, a step flowchart of a method for controlling movement of a controlled character provided by an embodiment of the present disclosure is shown, where a graphical user interface is provided by an electronic terminal, the electronic terminal displays, by the graphical user interface, a virtual scene and a controlled character located in the virtual scene.

Specifically, the following steps may be included.

In step 101, in response to an operation on the controlled character, a parkour movement state is entered; where, the parkour movement state is a state in which the controlled character is controlled, based on a terrain data, autonomously pass through a terrain object.

In open-world exploration games, such as martial arts open-world exploration games, since the terrain is too huge, the controlled characters sometimes are to move quickly (such as Rapid Movement) or explore in the vertical space. Therefore, the parkour movement state can be set, for example, the parkour movement state can be the movement state corresponding to the “Wall-running and Roof-leaping” skill, and the fast movement and the exploration in the vertical space can be realized.

During the running of the game, whether the player triggers the specified key may be monitored, such as a long-press of the Ctrl key. When the player triggers the specified key is monitored, the parkour movement state may be entered.

For the controlled character, it can be configured with a basic movement state and a parkour movement state. In the basic movement state, the player is to control all the movement operations of the controlled character, while in the parkour movement state, the player can only control the movement direction of the controlled character, while for other actions of the controlled character through terrain objects, the game application can automatically control the controlled character according to the terrain data in the virtual scene. Specifically, when the controlled character is in the basic movement state, the player is to control the movement direction and movement actions (running, jumping, crawling, and the like) of the controlled character. When the controlled character is in the parkour movement state, the player is to control the movement direction of the controlled character only, and the terminal can automatically control the controlled character to move according to the terrain data in the movement direction of the controlled character in the virtual scene. By comparison, in the basic movement state, the movement of the controlled character requires the player to input more control operations, and obstacle avoidance depends on the player's subjective decision, which brings more operation burden to the player. In the parkour movement state, the player is to control the movement direction of the controlled character only, and other movement controls can be automatically controlled by the terminal according to the terrain data, which greatly reduces the operation burden of the player. For example, when the controlled character is to cross a mountain, in the basic movement state, the player is to control the movement direction, climbing action and climbing opportunity of the controlled character, while in the parkour movement state, the player is to control the movement direction of the controlled character only, and the climbing action and climbing opportunity can be executed by the terminal.

It should be noted that for the basic movement state and the parkour movement state, it can effectively reduce the operation burden of the player from the perspective of player operation, while from the perspective of game performance, the controlled character in the parkour movement state can move in the virtual scene at a higher speed than the basic movement state, and can automatically avoid obstacles when encountering obstacles in the virtual scene. At the same time, during the moving process, the fluency and screen performance of the movement can be improved by executing corresponding actions and adding corresponding action special effects.

In the game, for the controlled character in the basic movement state, the player can input the operation aimed at the controlled character in the terminal to make the controlled character enter the parkour movement state, so as to simplify the movement control operation of the controlled character in the game and improve the movement speed of the virtual character. The virtual scene includes different terrains. The controlled character may be in different terrain objects when entering the parkour movement state. Therefore, when the controlled character enters the parkour movement state from different terrain objects, the controlled character can perform different actions. Specifically, when the controlled character moves in a horizontal terrain object (i.e., ground movement), in the basic movement state, it can include walking, running, sprinting, and the like, corresponding to different actions and different moving speeds, respectively. When entering the parkour movement state, the controlled character can move at a moving speed faster than sprinting, and the present disclosure does not limit this.

Optionally, corresponding detection nodes can be configured in the game application to detect game parameters involved in the running of the game application through the corresponding detection nodes, and when it is detected that the conditions are met, corresponding events are executed, including controlling the controlled character to perform corresponding actions.

In a specific implementation, a state trigger node corresponding to the parkour movement state can be configured. When the player controls the controlled character to enter the parkour movement state from the basic movement state, the terminal can switch the state trigger node from 0 to 1 and control the controlled character to enter the parkour movement state. At the same time, for the controlled character, in the basic movement state, the corresponding basic movement node corresponds to events such as “walk”, “run”, and “sprint”. After entering the parkour movement state, the event corresponding to the basic movement node can be replaced with the “parkour movement” event, so as to control the controlled character to move in the virtual scene with the movement action corresponding to the parkour movement state. In addition, in the process of moving in the parkour movement state, the terminal can also set the posture control node corresponding to the controlled character to the start state to control the body of the controlled character to tilt forward at a preset angle, simulate the posture of the corresponding point of the body of the controlled character in the case of rapid movement, and then the authenticity of the movement of the controlled character is improved.

In an optional embodiment, in case that the controlled character is moving on a horizontal terrain object in the virtual scene in a basic movement state, the terminal may enter, in response to the operation on the controlled character, the parkour movement state; the basic movement state is a state in which the controlled character is controlled, based on an operation of players on the controlled character, to move, and then the terminal can control the controlled character to move on the horizontal terrain object of the virtual scene in a parkour movement state, and the movement speed corresponding to the parkour movement state is greater than the movement speed corresponding to the basic movement state.

In another optional embodiment, when the controlled character is in the air, the terminal can respond to the operation on the controlled character, such as the player controlling the movement state of the controlled character through a preset physical key or virtual control (for example, a key on the keyboard can be used as a control key to trigger the controlled character to enter the parkour movement state, or a corresponding trigger control can be set in the graphical user interface to control the controlled character to enter the parkour movement state), so that the controlled character enters the parkour movement state and is controlled to perform a sprint action in the movement direction. For the controlled character in the air, at least two situations exist in the process of entering the parkour movement state and performing a sprint action in the movement direction.

In one case, after the sprint action is completed, no vertical terrain object exists in the movement direction of the controlled character to hinder its normal horizontal movement. In this case, after the sprint action is completed, the controlled character can fall from the air to the horizontal terrain object in a uniformly accelerated manner, and after landing, move on the horizontal terrain object with the action corresponding to the parkour movement state.

In the second case, when the controlled character is performing a sprint action, the terminal can control, in response to a process of the controlled character performing the sprint action and an existence of a vertical terrain object that meets a preset climbing condition in the movement direction, the controlled character to move from the air to the vertical terrain object. Therefore, for the controlled character in the air, the player can control it to enter a parkour movement state, so that the controlled character can move more flexibly and the operating burden of player can be reduced.

Optionally, taking the PC game as an example, the player can control the controlled character through the mouse and keyboard. Assuming that the movement state of the controlled character is moved by the Ctrl key on the keyboard, in the game, when the player does not touch the Ctrl key, the controlled character is controlled by the direction keys or preset direction keys on the keyboard (W to move forward, A to move left, S to move backward, D to move right), and the controlled character moves in a basic movement state; when the player presses the Ctrl key (short press or long press), the movement speed of the controlled character on the horizontal terrain object can be accelerated, and when a vertical terrain object that meets the preset climbing conditions is detected in the movement direction of the controlled character, the terminal can control the controlled character to automatically move from the horizontal terrain object to the vertical terrain object.

In one example, referring to FIG. 2, a schematic diagram of a movement scene provided in embodiments of the present disclosure is shown, where \textcircled{1} shows the moving trajectory of the controlled character from the ground to the wall when the controlled character moves on the ground (i.e., a horizontal terrain object) in a parkour movement state, a corresponding wall (i.e., a vertical terrain object) exists in the movement direction and the wall meets the climbing condition; \textcircled{2} shows the moving trajectory of the controlled character from the air to the wall when the controlled character receives an instruction to enter a parkour movement state in the air, enters the parkour movement state, sprints forward, and detects that a corresponding wall (i.e., a vertical terrain object) exists in the sprinting direction and the wall meets the climbing condition. It should be noted that after the controlled character sprints in the air, if no wall that meets the conditions is detected, the character can move according to the parkour movement state after landing. If a wall is detected again, the character can climb the wall according to process \textcircled{1}. Therefore, for the controlled character that is in the parkour movement state, when it encounters a vertical terrain object during the movement, the terminal can control the controlled character to automatically move to the vertical terrain object, so that the player no longer needs to judge the timing of “wall climbing” and no longer needs to input the corresponding control operation of “wall climbing”, the operating burden of player can be greatly reduced.

Optionally, in the foregoing second case, if the controlled character is in a basic movement state, the player is to wait for the controlled character to fall to the horizontal terrain object, and then trigger the movement control to control the controlled character to move to the corresponding vertical terrain object, and then control the controlled character to climb up the vertical terrain object with a corresponding climbing action, or trigger the jump control to control the virtual object to jump over the vertical terrain object with a corresponding jumping action. When the controlled character is in the air, if the player presses the movement state control key (or movement state control, such as the Ctrl key or the corresponding virtual control, and the like) while keeping the movement joystick (or movement control key) triggered, when the controlled character is controlled to enter the parkour movement state, the controlled character in the parkour movement state can perform a corresponding sprint action in the air, approach the vertical terrain object, and when approaching the vertical terrain object and detecting that the conditions are met, the controlled character moves directly from the air to the vertical terrain object. The sprint action and the “wall climbing” action are executed in a continuous manner, the operation of player is simplified, the operating burden of player is reduced, and the corresponding game immersion of player when controlling the controlled character to move in the virtual scene is improved.

In a specific implementation, when entering a parkour movement state in the air and if a vertical terrain object that meets the climbing condition is detected in the movement direction, the terminal can control the controlled character to perform the sprint action and reach a first detection point corresponding to the vertical terrain object; and control the controlled character to perform a jumping action and move from the first detection point to the vertical terrain object, and control the controlled character to move along a vertical surface of the vertical terrain object. The first detection point may be a jumping point for moving from the air to the vertical terrain object. When the controlled character performs a sprint action, if a vertical terrain object is detected in the movement direction, and the vertical terrain object meets the climbing condition, the terminal can select the first detection point from the movement direction of the controlled character, and then when the controlled character performs a sprint action to move to the first detection point, the terminal is triggered to control the controlled character to move from the first detection point to the vertical terrain object, so as to achieve displacement between the air and the vertical terrain object.

In one example, for a controlled character in the air, a controlled character in a jumping state and a controlled character falling from a height may be included. In this case, the air detection node can be used to determine whether the controlled character is in the air, and to determine what kind of animation to select after the controlled character enters the parkour movement state, including the animation of wall climbing from the air and the animation of wall climbing from the ground after landing from the air.

In addition, for the detection of terrain data, the terminal can emit multiple first rays in the movement direction of the controlled character, and emit second rays in a preset direction at multiple positions on the first rays, so as to detect the position information of terrain objects within a preset distance in the movement direction of the controlled character through the second rays. When a vertical terrain object that meets the climbing conditions is detected within 1 meter in the movement direction of the controlled character based on the ray detection method, an event of moving from the air to the vertical terrain object is triggered, and then the terminal can control the controlled character to perform a corresponding action to move from the air to the vertical terrain object.

Optionally, after the controlled character reaches the vertical terrain object, the terminal can also perform continuous terrain data detection on the vertical terrain object. Specifically, the terminal can emit multiple first rays in the movement direction of the controlled character, and emit second rays in a preset direction at multiple positions on the first rays, thereby detecting the position information of the vertical surface of the vertical terrain object within a preset distance in the movement direction of the controlled character through the second rays, so as to obtain terrain data corresponding to the vertical terrain object, and then control the controlled character to move on the vertical terrain object according to the terrain data.

In step 102, in response to a movement of the controlled character in the virtual scene in the parkour movement state, a terrain object in the virtual scene and a terrain data of the terrain object are determined.

After entering the parkour movement state, during the movement of the controlled character, the virtual scene in which the controlled character is located can be automatically detected, such as detecting obstacles in front, detecting terrain, and the like, and then the terrain objects in the virtual scene and the terrain data of the terrain objects can be determined.

In step 103, the controlled character is controlled to autonomously pass through terrain object with parkour movement action adapted to the terrain data.

In order to adapt to different terrain conditions in the virtual scene, multiple parkour movement actions can be set in the parkour movement state. The parkour movement actions can be set according to whether the controlled character mainly moves horizontally or vertically in the virtual scene, such as ground movement, wall movement, and water movement. The ground movement is mainly horizontal movement (due to the existence of obstacles, it also includes moving vertically for a short time), that is, moving on the ground. The wall movement is vertical movement, that is, moving on the wall, and the water movement can be a special ground movement, that is, moving on the water surface (it also includes moving vertically on the water surface, such as jumping on the water surface, enabling the light-footed techniques seen in martial arts folklore).

Regardless of moving horizontally or vertically, there are different terrains, different obstacles and other barriers. In order to avoid obstacles and adapt to the terrain for fast movement, different parkour movements can be set according to different terrain conditions. Under different parkour movement actions, the movement action of the controlled character and its corresponding animation performance are also different.

During the movement of the controlled character, the terrain conditions in the virtual environment are detected in real time, such as whether the controlled character moves vertically or horizontally next, or whether the controlled character is on the water, and then the parkour movement action that adepts to the terrain data is determined. The controlled character is controlled to autonomously pass through the terrain object to achieve fast movement to adapt to different terrain conditions, thereby improving the smoothness of the exploration of the controlled character in the open world, and can display different target movement animations according to different target movement strategies, thereby enriching the action performance and enabling more special effects performance.

It should be noted that since the main function of the parkour movement state is to facilitate the controlled character to move quickly, after entering the parkour movement state, during the movement of the controlled character, controlling the controlled character to enter different movement actions is automatically triggered according to the terrain conditions without user operation.

In these embodiments of the present disclosure, in response to an operation on the controlled character, a parkour movement state is entered; where, the parkour movement state is a state in which the controlled character is controlled, based on a terrain data, to autonomously pass through a terrain object; in response to a movement of the controlled character in the virtual scene in the parkour movement state, a terrain object in the virtual scene and a terrain data of the terrain object are determined; and the controlled character is controlled to autonomously pass through terrain object with parkour movement action adapted to the terrain data. The controlled character can be controlled to move automatically by adopting the parkour movement action adapted to the terrain data, so that the controlled character can adapt to different terrain conditions and can obtain a faster moving speed, and the smoothness of the controlled character in open world exploration is improved.

In open world games, the state of the controlled character can be divided into a standing standby state or a moving state according to whether the position of the controlled character changes. When the controlled character is in the standing standby state, the position of the controlled character does not change, and when the controlled character is in the moving state, the position of the controlled character changes.

The movement state of the controlled character can be divided into a basic movement state and a parkour movement state according to different movement logics. When the controlled character is in the basic movement state, the first movement logic of the controlled character is: when an obstacle exists in front of the movement and the player does not intervene in the operation of the controlled character, the controlled character stops moving at the obstacle due to being blocked. When the player intervenes in the operation of the controlled character, the player can operate according to experience to control the controlled character to pass through the obstacle. When the controlled character is in the parkour movement state, the second movement logic of the controlled character is: according to the terrain data of the surrounding environment of the controlled character, the controlled character is controlled to autonomously pass through the terrain object. For example, when the terrain object is a horizontal terrain object, when an obstacle exists, the controlled character can autonomously pass through above or along the surface of the obstacle without the operation of player. The horizontal terrain object can be a ground terrain object or a water surface terrain object.

It should be noted that, in these embodiments of the present disclosure, the obstacle may be a convex obstacle on a horizontal terrain object, such as a low building within a preset height, and the like. ; the obstacle may also be a terrain object.

In one example, the ground may be uneven due to convex dirt or stone piles. When the current ground height of the controlled object is lower than the ground height in front of the controlled object, and the height difference meets the preset conditions, the ground object in front can be regarded as an obstacle to the current position of the controlled character.

In another example, when water surface exists in front of the controlled character, the water surface object can be regarded as an obstacle to the controlled character; when the controlled character is in a basic movement state, when the player does not intervene in the operation, the controlled character moves from the ground to the water surface, and the controlled character can pass through the water surface object with a water surface specific movement posture, and the water surface specific movement posture can be specifically expressed as a swimming posture of the controlled character in the water; when the controlled character is in a parkour movement state, the controlled character can autonomously pass through above the water surface terrain.

It should be noted that the water surface objects in these embodiments of the present disclosure not only refer to lakes, streams and other water surface objects in virtual games, but may also refer to puddles, and the like. The water surface objects in these embodiments of the present disclosure may also include terrain objects such as swamps and wetlands with similar water properties.

In one example, the basic movement state can be divided into a first basic movement state and a second basic movement state according to the moving speed and the moving posture. When the controlled character moves on a terrain object, without the need to cross obstacles (i.e., blockers), the moving speed and the moving posture of the parkour movement state are different from the moving speed and the moving posture in the basic movement state, where the moving speeds of the basic movement state and the parkour movement state are arranged from small to large as follows: first basic movement state<second basic movement state<parkour movement state.

In these embodiments of the present disclosure, in the parkour movement state, obstacles in the horizontal terrain data can be passed through according to the terrain data. Compared with the player crossing the obstacles based on experience, the obstacles can be crossed quickly, thereby enhancing the gaming experience for players.

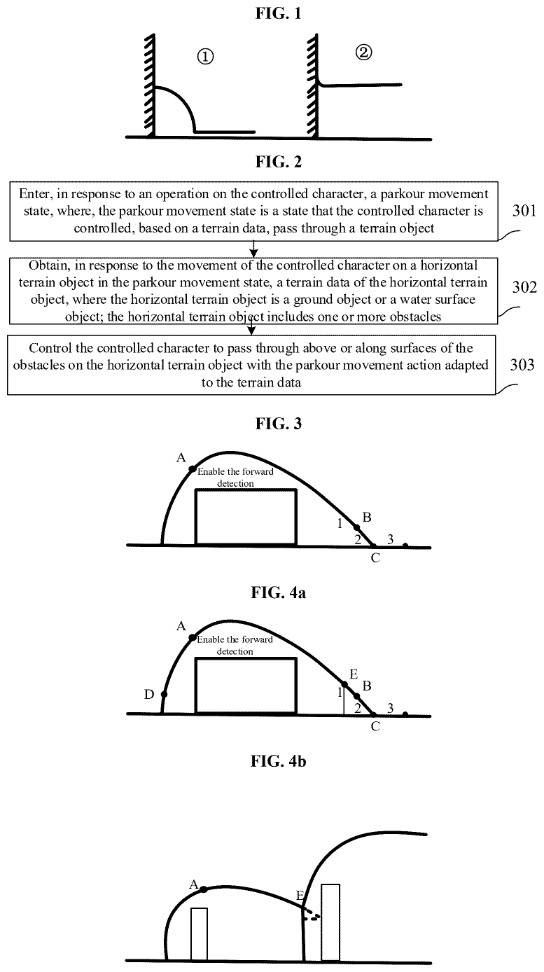

Referring to FIG. 3, a step flowchart of a method for controlling movement of a controlled character provided by an embodiment of the present disclosure is shown, where a graphical user interface is provided by an electronic terminal, the electronic terminal displays, by the graphical user interface, a virtual scene and a controlled character located in the virtual scene.

Specifically, the following steps may be included.

In step 301, in response to an operation on the controlled character, a parkour movement state is entered, where, the parkour movement state is a state in which the controlled character is controlled, based on a terrain data, pass through a terrain object.

When the controlled character is in the basic movement state, when the player performs a target operation on the basic movement state, the controlled character can be controlled to switch from the basic movement state to the parkour movement state. In the parkour movement state, the controlled character can autonomously pass through the obstacle when encountering an obstacle.

The target operation may refer to a long press operation on a certain control on the input device. While the player holds down the control, the controlled character is in a parkour movement state. When the player releases the control, the controlled character exits the parkour movement state. After exiting the movement state, the controlled character can switch to a basic movement state or a standing standby state.

In step 302, in response to the movement of the controlled character on a horizontal terrain object in the parkour movement state, a terrain data of the horizontal terrain object is obtained, where the horizontal terrain object is a ground object or a water surface object; the horizontal terrain object includes one or more obstacles.

After the controlled character enters the special effect movement state, the environment in which the controlled character is located can be monitored during the movement on the horizontal terrain object to obtain the terrain data of the horizontal terrain object.

In some embodiments, terrain data may refer to convexity and concavity information or information on changes in terrain objects (such as from a ground object to a water surface object or from a ground object to a vertical terrain object) in the movement direction of the controlled character, where the convexity and concavity information may be the convexity and concavity caused by the unevenness of the horizontal terrain object itself, and the convexity and concavity information may also be the convexity and concavity formed in the virtual scene due to the combination of other objects placed on the horizontal terrain object (for example, a table placed on the ground) and the horizontal terrain object.

In one example, terrain data may include, but is not limited to, being characterized as the following types.
Type 1: a first obstacle exists in the movement direction of the controlled character, where the first obstacle is a convex land in the movement direction of the controlled character.
Type 2: a first depression exists in the movement direction of the controlled character.

In one example, in the special effect movement state, the first forward detection along the movement direction of the controlled character can be enabled to obtain the terrain data of the controlled character in the movement direction. The first forward detection is used to detect whether an obstacle exists within a first preset distance in front of the controlled character, and the first preset distance can be set according to actual detection requirements.

In one embodiment of the present disclosure, obtaining the terrain data of a horizontal terrain object includes: setting a collision ball that moves with the movement of the controlled character in front of the controlled character, and detecting obstacles at the position of the collision ball to obtain terrain data.

In practical applications, a collision ball can be set in the movement direction of the controlled character, and the collision ball can move with the movement of the controlled character. During the movement of the controlled character, continuously detecting whether there are obstacles at the position of the collision ball, thereby realizing the detection of terrain data in the movement direction.

In one embodiment of the present disclosure, the method further includes: obtaining movement parameters of the controlled character, and adjusting the positional relationship between the collision ball and the controlled character according to the movement parameters.

In practical applications, the movement parameters of the controlled character, such as movement speed, movement direction and other movement parameters, can be determined, and then during the movement of the controlled character, the position relationship between the collision ball and the controlled character can be adjusted to better perform the detection of terrain data in the virtual scene.

In one embodiment of the present disclosure, the method further includes: obtaining the moving speed of the controlled character, and adjusting the distance between the collision ball and the controlled character according to the magnitude of the moving speed, so that the distance between the collision ball and the controlled character is positively correlated with the magnitude of the moving speed at least within a set distance range.

In practical applications, the distance between the collision ball and the controlled character can be adjusted according to the moving speed of the controlled character. Specifically, when the controlled character is in a parkour move state, the moving speed of the controlled character can be obtained, and the target distance between the controlled character corresponding to the moving speed and the collision ball can be determined, and then the distance between the collision ball and the controlled character can be adjusted according to the target distance.

The distance between the collision ball and the controlled character is positively correlated with the moving speed within the set distance range, that is, within the set distance range, the greater the moving speed of the controlled character, the farther the distance between the collision ball and the controlled character, and the smaller the moving speed of the controlled character, the smaller the distance between the collision ball and the controlled character.

For example, the distance threshold can be set to 1 meter to 3 meters. When the moving speed is slow to a certain extent, the distance between the collision ball and the controlled character is fixed at 1 meter. When the moving speed of the controlled character decreases further, the detection distance does not be further shortened; when the moving speed increases to a certain extent, the distance between the collision ball and the controlled character is fixed at 3 meters. When the moving speed of the controlled character continues to increase, the detection distance does not be further increased.

In one embodiment of the present disclosure, detecting the obstacle information at the location of the collision ball to obtain terrain data, including: when it is detected that the collision ball collides with a first obstacle, detecting upward along the first obstacle to determine the height information of the first obstacle, and detecting forward along the current movement direction of the controlled character to determine the width information of the first obstacle.

In practical applications, after the collision ball detects the obstacle, the height and width of the obstacle can be determined. Specifically, when the collision ball detects the obstacle, the surface of the obstacle can be detected upward and forward along the movement direction to determine the height and width of the obstacle.

In one example, the collision ball can also detect the type of obstacle, and the obstacle type is used to determine whether the obstacle is a passable obstacle for the controlled object. When the controlled object is determined as a passable obstacle, a parkour movement action adapted to the terrain data is performed to control the controlled character to pass through above or along the surface of the obstacle of the horizontal terrain object.

For example, in a virtual scene, when a controlled character is in a parkour movement state on the ground or water, for a higher wall, the virtual character can only climb up the wall but cannot directly cross it.

In step 303, the controlled character is controlled to pass through above or along surfaces of the obstacles on the horizontal terrain object with the parkour movement action adapted to the terrain data.

After obtaining the terrain data, the parkour movement action adapted to the terrain data is determined, and then the controlled character pass through above or along surfaces of the obstacles on the horizontal terrain object in an alternative way with the parkour movement action.

In one embodiment of the present disclosure, controlling the controlled character to pass through above or along surfaces of the obstacles on the horizontal terrain object with the parkour movement action adapted to the terrain data may include the following sub-steps.

The character parameters of a controlled character are obtained; a target parkour movement action is determined from a plurality of candidate parkour movement actions according to terrain data; the target parkour movement action is adjusted according to the character parameters, and the controlled character is controlled to pass through above or along the surface of an obstacle of a horizontal terrain object according to the adjusted target parkour movement action.

The character parameters include at least one of a character footstep parameter and a character gender parameter.

The preset animation library may be pre-set with candidate parkour movement actions corresponding to various terrain data, and the candidate parkour movement actions may be used as parkour movement action templates set for the character, so that after determining the terrain data, the target parkour movement action corresponding to the terrain data may be determined.

The candidate parkour movement actions can be divided into three categories: a crossing action, a jumping up action, and a jumping down action. Different actions can be set for the crossing action, the jumping up action, and the jumping down action according to the height.

For example, the crossing action (Cross animation) can be divided into four animations according to the height: CrossLow, CrossMiddle, CrossMidst and CrossHigh. Each animation is set with an applicable height. When the crossing action is determined to be used, a highly adapted animation can be determined in the preset animation according to the height of the obstacle as the crossing action performed by the controlled character in the process of crossing the obstacle. The height of the crossing action is higher than the height of the obstacle.

The jumping up action (JumpUp animation) can be divided into three animations with three different heights. JumpUp animations below 0.65 m are used to speed up the running animation on the ground in parkour movement action. Small JumpUp animations between 0.65 m and 1.5 m correspond to stride animations. In practical applications, the jumping up time and frequency can be calculated based on the footstep parameters of the controlled character. JumpUp animations above 1.5 m correspond to jump animations.

The jumping down action can be divided into acceleration running, small jumping down animation, 1.8 m-4 m jumping down animation, 4 m-10 m jumping down animation, and leap of faith over 10 m.

In practical applications, animation of the controlled character in different crossing orientations of the left and right feet may also be configured for the crossing action, the jumping up action, and the jumping down action.

When the first obstacle is detected, the action type is determined according to the terrain information of the obstacle and the width information of the first size parameter (where the action type may include a crossing action, a jumping up action, and a jumping down action), and then, based on the height information, a candidate parkour movement action (i.e., animation) matching the height information can be determined from the corresponding action type, and then the candidate parkour movement action with different crossing orientations can be selected according to the left and right foot states of the controlled character.

In practical applications, the special effect movement action performed by the controlled character can be a target special effect movement action obtained by adaptively adjusting the preset candidate special effect movement actions in combination with the state of the controlled character itself and the environment in which the controlled character is located.

It should be noted that in practical applications, different candidate parkour movement actions can be pre-set according to different scenes, so that when the controlled character is in a parkour movement state, the corresponding candidate parkour movement actions can be used in combination with the scene to enrich the action performance of the controlled character in the virtual scene.

After determining the target parkour movement action, the target parkour movement action can be adjusted according to the character parameters to obtain the target parkour movement action corresponding to the controlled character. Specifically, the relative angle position of the current footsteps of the controlled character can be matched to the footstep position of the target parkour movement action, and the start time of the target parkour movement action can be changed to achieve the connection of the footsteps and avoid slipping. The character gender parameter is used to switch between male and female characters.

In one embodiment of the present disclosure, when the controlled character moves on the horizontal terrain object with the action in a parkour movement state, the distance between the virtual camera in the virtual scene and the controlled character is increased.

In practical applications, when the controlled character moves on a horizontal terrain object with the action in a parkour move state, the movement speed of the controlled character can be faster than the movement speed in the basic move state. The distance between the virtual camera and the controlled character in the virtual scene can be increased to increase the field of view of the lens and adjust the focal length to be smaller, making it easier for players to see the terrain clearly and perform operations.

In one example, after the distance between the virtual camera and the controlled character in the virtual scene is increased, the virtual camera is controlled to gradually follow the controlled character, thereby enhancing the feeling of fast movement through the lens of the virtual camera.

In one embodiment of the present disclosure, it also includes: when the controlled character moves on the horizontal terrain object with the action in a parkour move state, determining the current angle of the virtual camera in the virtual scene; when the current angle is the side angle of the controlled object, adjusting the current angle of the virtual camera to the back angle of the controlled character.

In practical applications, when the virtual camera faces the side of the controlled character, due to the limited visual angle, the lens of the virtual camera can be automatically and gradually rotated to the back of the controlled character to facilitate player operation.

In one embodiment of the present disclosure, the method further includes: when the controlled character is in a turning state or a stationary state, stopping the obtaining of the terrain data in the horizontal terrain object.

When the controlled character is in a parkour movement state, it can be determined whether the controlled character is in a turning or stationary state. When it is determined that the controlled character is in a turning or stationary state, the acquisition of terrain data in the horizontal terrain object can be stopped.

In one embodiment of the present disclosure, after obtaining the terrain data of the horizontal terrain object, it further includes: during the process of controlling the controlled character to pass through above or along surfaces of the obstacles on the horizontal terrain object with the parkour movement action adapted to the terrain data, controlling, in responses to the controlled character exiting the parkour movement state, the controlled character to keep moving when detecting that the controlled character is in the air.

In practical applications, when exiting the parkour move state, the controlled character may be in a standing still state, and when the controlled character exits the parkour move state while passing through over or along the surface of an obstacle of a horizontal terrain object, if the controlled character is in a suspended state, the controlled character can be controlled to fall from the air, that is, to keep moving.

In one embodiment of the present disclosure, when a controlled character moves on a horizontal terrain object with the action in a parkour move state, a detection ray is emitted along a preset ray direction with the controlled character as the ray emission point to determine material information of the collision position of the detection ray; the category of the horizontal terrain object is determined based on the material information, and the category includes at least ground objects and water objects.

Through ray detection, it can be determined whether the object in front of the controlled character is a ground object or a water object.

When the terrain data represents a switching from ground objects to water surface objects, the controlled character can pass through above or along the water surface with a parkour movement action adapted to the water surface object.

In these embodiments of the present disclosure, in response to an operation on a controlled character, a parkour movement state is entered, where the parkour movement state is a state in which the controlled character is controlled, based on a terrain data, to pass through a terrain object; in response to the movement of the controlled character on a horizontal terrain object in the parkour movement state, terrain data of the horizontal terrain object is obtained, where the horizontal terrain object is a ground object or a water surface object; the horizontal terrain object includes one or more obstacles; the controlled character is controlled to pass through above or along the surface of the obstacles of the horizontal terrain object by a parkour movement action adapted to the terrain data, thereby achieving that in the parkour movement state, obstacles in the horizontal terrain data can be passed through according to the terrain data. Compared with the player crossing the obstacles based on experience, the obstacles can be crossed quickly, thereby enhancing the gaming experience for players.

In one embodiment of the present disclosure, controlling the controlled character to pass through above or along surfaces of the obstacles on the horizontal terrain object with the parkour movement action adapted to the terrain data, includes the followings.

When the terrain data indicates that a first obstacle exists in a movement direction of the controlled character, determining a first size parameter of the first obstacle; and controlling the controlled character to pass through above or along a surface of the first obstacle with a parkour movement action adapted to the first size parameter.

The first obstacle is the convex ground in front of the controlled character. The convex ground may be the convexity and concavity caused by the unevenness of the ground object itself, and the convexity and concavity information may also be the convexity and concavity formed in the virtual scene due to other objects placed on the ground object or the water surface (for example, a table placed on the ground or a boat on the water).

In one example, the parkour movement action for the first obstacle may specifically be a jumping action, which may include a crossing action over the first obstacle, a jumping up action to jump to the first obstacle, and a jumping down action.

In one embodiment of the present disclosure, the first size parameter includes at least height information and width information of the first obstacle, the width information of the first obstacle is the width along the movement direction of the controlled character, and the controlled character is controlled to pass through above or along the surface of the first obstacle with a parkour movement action adapted to the height information. Specifically, when the width information is less than a preset width threshold, the controlled character is controlled to pass through above the first obstacle according to a jumping action adapted to the height information.

In practical applications, different heights may correspond to different parkour movement actions. After determining the height information of the first obstacle, the appropriate parkour movement action may be determined according to the height information, and then the controlled character may be controlled to pass through above or along the surface of the first obstacle in an alternative way.

When the width information is less than a preset width threshold, the controlled character can directly jump over the first obstacle through a highly adapted jumping action, and the special effect moving action used in this process is a crossing action.

In one embodiment of the present disclosure, the method further includes: during a jump process of the controlled character, when the controlled character reaches a first crossing position, enabling a second forward detection along the movement direction of the controlled character to detect a second obstacle, where the first crossing position is a position on a crossing trajectory of the controlled character crossing the first obstacle.

In practical applications, the controlled character can use parkour movement actions to perform crossing actions, and the parkour movement actions can constitute a crossing trajectory of the controlled character. When the controlled character reaches the first crossing position according to the crossing trajectory, the second forward detection can be triggered to detect the second obstacle along the movement direction of the controlled character.

In one example, the preset distance of the second forward detection is smaller than the detection distance of the first forward detection. For example, the detection distance of the second forward detection may be 1 m, and the detection distance of the first forward detection may be 3 m.

The second forward detection can detect the distance to the obstacle, and when an obstacle is detected, the wall climbing from the air is triggered; the first forward detection can detect the distance to the obstacle, and when an obstacle is detected, the size parameters of the obstacle can be determined, so as to perform the jumping action for the obstacle again in the air according to the size parameters.

It should be noted that the first crossing position can be set according to actual needs, and no excessive restrictions are imposed on this in these embodiments of the present disclosure.

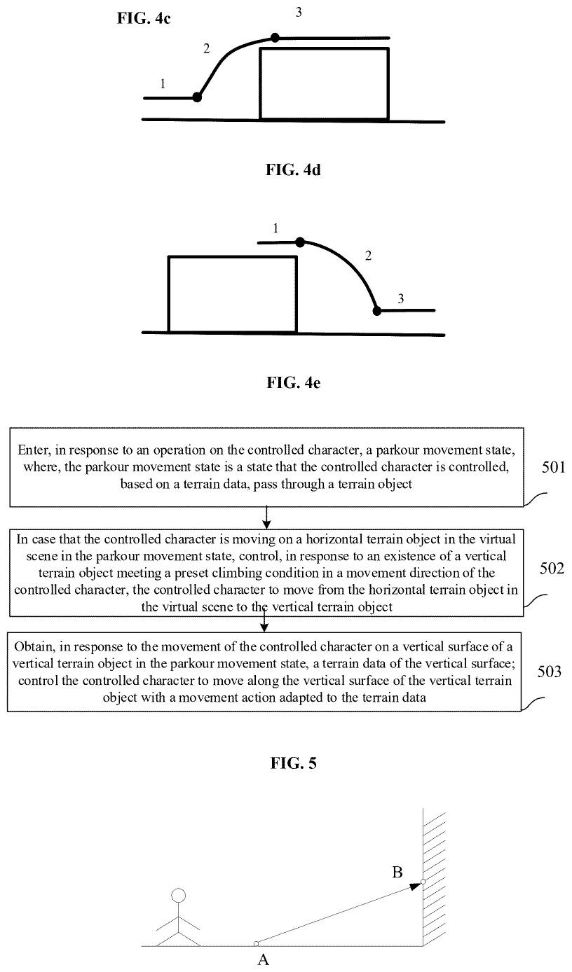

As shown in FIG. 4a, it is a schematic diagram of a crossing trajectory: the Cross animation composed of the crossing trajectory of the crossing action is divided into three sections, the jump section (i.e., the 1st stage composed of the crossing trajectory before point B in FIG. 4a), the loop section (i.e., the 2nd stage from point B to point C in FIG. 4a), and the end section (i.e., the 3rd stage after point C in FIG. 4a).

The second forward detection can be enabled at point A in the jump section (i.e., the first crossing position), and the detection is a wall climbing detection. When an obstacle is detected, the wall climbing action can be executed.

At the end of the jump section, the speed information of the jump can be obtained at point B, and the loop can be switched based on the speed information to achieve the connection between different stages of the crossing action.

In practical applications, different loop animations are set in combination with parameters such as the height of the controlled character from the ground and the action type to enrich the actions of the controlled character.

When the controlled character moves from point B to point C, the loop section can be connected to the end stage when the controlled character lands.

After reaching point B, the action selection of the controlled character after landing is determined according to the real-time status of the controlled character. The action of the controlled character after landing may include standing still after landing or continuing to run after landing. When continuing to run after landing is chosen, the character continues to run with special effects moving actions and detects terrain data with the first forward detection during the running process.

In one embodiment of the present disclosure, the method further includes: when the controlled character reaches a second crossing position, disabling the first forward detection used for obtaining the terrain data, where the second crossing position is a position on the crossing trajectory before the first crossing position, and a detection distance of the first forward detection is greater than a detection distance of the second forward detection.

In practical applications, when the controlled character reaches the second crossing position according to the crossing trajectory, the first forward detection for obtaining terrain data can be disabled to avoid confusion in the entire crossing trajectory due to the controlled character continuously detecting the first obstacle by the first forward detection.

When the controlled character moves along the crossing trajectory, the controlled character can first disable the long-distance first forward detection at the second crossing position, and then enables the short-distance second forward detection at the first crossing position.

In one embodiment of the present disclosure, the method further includes: when the controlled character reaches a third crossing position, disabling the second forward detection and enabling the first forward detection along the movement direction of the controlled character, where the third crossing position is a position, at a preset height in a falling stage, on the crossing trajectory after the first crossing position.

In practical applications, on the crossing trajectory, the controlled character passes through the second crossing position, the first crossing position, and the third crossing position in sequence. When the controlled character reaches the third crossing position, the short-distance first forward detection can be disabled and the long-distance first forward detection can be enabled at the same time.

In one embodiment of the present disclosure, the method also includes: if the controlled character detects a second obstacle in the movement direction of the controlled character after enabling the first forward detection at the third crossing position, a second size parameter of the second obstacle is determined; and the controlled character is controlled to pass through above or along the surface of the second obstacle with a parkour movement action adapted to the second size parameter.

The second size parameter may include relative height information and/or thickness information of the second obstacle, and the relative height information is the relative height information of the second obstacle relative to the baseline with the current height of the controlled character as the baseline.

With respect to the way in which the controlled character passes through the second obstacle, the description of passing through the first obstacle can be referred to, and will not be elaborated here.

In one embodiment of the present disclosure, the method further includes: if the controlled character detects the second obstacle after enabling the second forward detection at the first crossing position, controlling the controlled character to perform a sprint action in the movement direction, and move from air to a vertical terrain object formed by the second obstacle when the second obstacle meets a preset climbing condition.

In practical applications, when the controlled character detects the second obstacle forward, the controlled character performs a sprint action to prepare to climb the wall. When the second obstacle meets the preset climbing conditions, the controlled character moves from the air to the vertical terrain object formed by the second obstacle to achieve the wall climbing from the air.

When the controlled character performs a crossing action, the controlled character is in an air-borne state, the controlled character in the parkour movement state can perform a corresponding sprint action in the air, approach the vertical terrain object (i.e., the second obstacle), and when the controlled character approaching the vertical terrain object and detecting that the conditions are met, the controlled character moves directly from the air to the vertical terrain object. The sprint action and the “wall climbing” action are executed in a continuous manner, the operation of player is simplified, the operating burden of player is reduced, and the corresponding game immersion of player when controlling the controlled character to move in the virtual scene is improved.

In a specific implementation, when entering a parkour movement state in the air and if a vertical terrain object that meets the climbing condition is detected in the movement direction, the terminal can control the controlled character to perform the sprint action and move to a first detection point corresponding to the vertical terrain object; and control the controlled character to perform a jumping action and move from the first detection point to the vertical terrain object, and control the controlled character to move along a vertical surface of the vertical terrain object. The first detection point may be a jumping point for moving from the air to the vertical terrain object. When the controlled character performs a sprint action, if a vertical terrain object is detected in the movement direction, and the vertical terrain object meets the climbing condition, the terminal can select the first detection point from the movement direction of the controlled character, and then when the controlled character performs a sprint action to move to the first detection point, the terminal is triggered to control the controlled character to move from the first detection point to the vertical terrain object, so as to achieve displacement between the air and the vertical terrain object.

In one embodiment of the present disclosure, the method further includes: when the controlled character reaches a fourth crossing position, downward detecting a current distance to ground of the controlled character, where the fourth crossing position is a position after a highest point on the crossing trajectory of the controlled character crossing the first obstacle.

The fourth crossing position can be a crossing position before the third crossing position, which is used to detect the distance from the ground of the controlled character. When the distance from the ground is the first distance from the ground, it is determined that the controlled character reaches the third crossing position, the execution of disabling the second forward detection and enabling the first forward detection is triggered.

In one example, the fourth crossing position is a position after a highest point on the crossing trajectory of the controlled character crossing the first obstacle.

In one embodiment of the present disclosure, the method further includes: when the current distance to ground is detected as a second distance to ground, controlling the controlled character to perform a landing action.

In practical applications, when the distance from the ground of the controlled character is detected to be the second distance from the ground, it is determined that the controlled character is about to land, and when the controlled character is about to land, a preset landing action can be performed, which can be the action of standing still after landing or the action of continuing to run after landing, so as to connect the whole special effect movement action of the controlled character landing from the air.

As shown in FIG. 4b, it is another schematic diagram of the crossing trajectory, where point D is the second crossing position, and the first forward detection is enabled at point D; point A is the first crossing position, and the second forward detection is enabled at point A; point E corresponds to the third crossing position, and the second forward detection is disabled at point E, and the first forward detection is enabled at point E. Point E corresponds to the first distance from the ground (such as set at 1.7 m), and the fourth crossing position is set before point E. The downward detection is enabled at the fourth crossing position to determine the distance from the ground. When it is detected that the controlled character is at the second distance from the ground (such as 0.4 m), the loop section is used to connect the end section and then it is determined that the landing action is del (standing still) or run (running).

FIG. 4c is a schematic diagram of a secondary crossing. When a second obstacle is detected by the first forward detection at point E, the crossing is performed again for the second obstacle. If the second obstacle is detected by the second forward detection performed between point A and point E, the wall climbing from the air is performed.

In an embodiment of the present disclosure, after controlling the controlled character to cross the first obstacle object from above the first obstacle, the method further includes: when the controlled character is in a movement state, the terrain data of a horizontal terrain object is obtained.

In practical applications, after the crossing action is completed, at the landing point, if the controlled object is in a movement state, the first forward detection can be continued to obtain the terrain data of the horizontal terrain object.

When the controlled character completes the crossing action and is in a standing still state at the landing point, the first forward detection is disabled.

In one example, when the crossing action is completed and the controlled character is in a movement state, the footstep synchronization track can be performed.

In one embodiment of the present disclosure, the first size parameter includes height information and width information of the first obstacle, and controlling the controlled character to pass through above or along the surface of the first obstacle with the parkour movement action adapted to the height information includes: when the width information is greater than or equal to the preset width threshold, controlling the controlled character to jump onto the first obstacle from a surface of the horizontal terrain object with a jumping action adapted to the height information, and pass through the first obstacle along the surface of the first obstacle.

In practical applications, when the width of the first obstacle is greater than or equal to the preset width threshold, that is, when the first obstacle is too wide, it is difficult for the controlled character to directly cross it. Therefore, an adaptive jumping action can be determined according to the height information to control the controlled character to jump from the current position to the first obstacle, so that the controlled character can pass through along the surface of the first obstacle.

As shown in FIG. 4d, it is a schematic diagram of a jumping up trajectory in some embodiments of the present disclosure. The entire jumping up process can be divided into running before jumping up, jumping up and running after jumping up.

In these embodiments of the present disclosure, in response to an operation on a controlled character, a parkour movement state is entered, where the parkour movement state is a state in which the controlled character is controlled, based on a terrain data, to pass through a terrain object; in response to the movement of the controlled character on a horizontal terrain object in the parkour movement state, terrain data of the horizontal terrain object is obtained, where the horizontal terrain object is a ground object or a water surface object; the horizontal terrain object includes one or more obstacles. When the terrain data indicates that a first obstacle exists in a movement direction of the controlled character, a first size parameter of the first obstacle is determined; and the controlled character is controlled to pass through above or along a surface of the first obstacle with a parkour movement action adapted to the first size parameter. It is achieved that in the parkour movement state, obstacles in the horizontal terrain data can be passed through according to the terrain data. Compared with the player crossing the obstacles based on experience, the obstacles can be crossed quickly, thereby enhancing the gaming experience for players.

In one embodiment of the present disclosure, controlling the controlled character to pass through above or along surfaces of the obstacles on the horizontal terrain object with the parkour movement action adapted to the terrain data, includes the followings.

When the terrain data indicates that a first depression exists in a movement direction of the controlled character, the height information of a current position of the controlled character with the first depression is determined; and the controlled character is controlled to jump from the current position to the first depression according to a jumping action adapted to the height information.

When the front position of the controlled character is concave relative to the current position of the controlled character, and the height difference between the front position of the controlled character and the current position of the controlled character meets the preset conditions, it is determined that the terrain data represents the existence of a first concave ground in the movement direction of the controlled character, where the preset conditions can be set according to the implementation scene, and no excessive restrictions are made on this in the present disclosed embodiments.

The first concave ground may include but is not limited to the following types.
Type 1: when the controlled character is on flat ground or water surface, the first concave ground in the front of the movement direction may be a sunken ground parcel that collects water (e.g., a waterfall).
Type 2: when the controlled character is located on the first obstacle (other objects placed on the ground object or the water surface forming a convex ground, for example, a table placed on the ground or a boat on the water surface), the concave ground is flat land or water surface.

After determining the height information, a jumping down action adapted to the height information can be determined, and then the controlled character is controlled to jump down to the first concave ground according to the jumping down action. FIG. 4e is a schematic diagram of a jumping down trajectory in some embodiments of the present disclosure.

In one example, during the jumping down process, since the controlled character is suspended in the air, the detection mode can be switched to the second forward detection, that is, the first forward detection is disabled and the second forward detection is enabled.

When the second obstacle is detected forward, when the controlled character moves along the jumping down trajectory until touches the second obstacle, the controlled character is controlled to perform a sprint action in the movement direction, and when the second obstacle meets the preset climbing conditions, the controlled character is controlled to move from the air to the vertical terrain object formed by the second obstacle, that is, wall climbing from the air.

When the distance from the ground of the controlled character is the first distance from the ground, the first forward detection can be enabled again. When a second obstacle in the movement direction of the controlled character is detected after the first forward detection is enabled, the second size parameter of the second obstacle is determined; and the controlled character is controlled to pass through above or along the surface of the second obstacle with a parkour movement action adapted to the second size parameter.

In one example, the different turning time may be set for each jump down at a different height, and the higher the jump down height, the longer the turning time.

In these embodiments of the present disclosure, in response to an operation on a controlled character, a parkour movement state is entered, where the parkour movement state is a state in which the controlled character is controlled, based on a terrain data, to pass through a terrain object; in response to the movement of the controlled character on a horizontal terrain object in the parkour movement state, terrain data of the horizontal terrain object is obtained, where the horizontal terrain object is a ground object or a water surface object; the horizontal terrain object includes one or more obstacles. When the terrain data indicates that a first depression exists in a movement direction of the controlled character, the height information of a current position of the controlled character with the first depression is determined; and the controlled character is controlled to jump from the current position to the first depression according to a jumping action adapted to the height information. It is achieved that in the parkour movement state, jumping down is performed when encountering the first concave ground. Compared with the player crossing the obstacles based on experience, the obstacles can be crossed quickly, thereby enhancing the gaming experience for players.

In open world games, a vast game world can be presented to players, where players can freely explore the game content in the game world, the game content is greatly enriched and the playability of the game is improved. For this type of game, the mainstream gameplay involves exploring, collecting, and the like in the game world. During the process of exploring and collecting, the diverse terrains in the game world bring rich and varied changes to players, but they also tend to increase the corresponding operational burden on players. That is, players are to perform different movement control operations for the controlled character according to the changes in terrain during its movement. Therefore, how to simplify the movement control of the controlled character based on the terrain and enhance the immersion of player in the movement of the controlled character in the game world has become the main influencing factor for players to obtain a good gaming experience. For example, when players are to control the controlled character to reach a destination, if the movement control of the controlled character can be simplified, it can bring a good gaming experience to players. In open world games, various terrain objects, such as grasslands, plains, hills, mountains, forests, buildings, and the like are included. The controlled characters can move in the horizontal direction of the game scene (such as running on the grassland, and the like), and can also move in the vertical direction of the game scene (such as climbing on the wall of the building, and the like). However, in the vertical exploration process (such as climbing walls, cliffs, and the like), the controlled characters can move in the vertical exploration through corresponding climbing actions. In this process, the whole process depends on the autonomous operation of player. The player is to judge the operation timing (such as when encountering an obstacle, it is to judge when to input the corresponding operation to control the controlled character to cross the obstacle, and the like), which easily brings a great burden to the game operation of player, and the controlled character moves slowly, which greatly reduces the exploration efficiency of the game world.

In this regard, in the game application of the present disclosure, for the controlled character controlled by the player, it can be configured with different basic movement states and parkour movement states. In the basic movement state, the player is to control all movement operations of the controlled character, while in the parkour movement state, the player can only control the movement direction of the controlled character, and for other actions of the controlled character passing through the terrain objects, the game application can automatically control the controlled character according to the terrain data in the virtual scene. Specifically, during the game process, the terminal can enter the parkour movement state in response to the operation on the controlled character. When the controlled character moves on the horizontal terrain object of the virtual scene in the parkour movement state, in response to the existence of a vertical terrain object that meets the preset climbing condition in the movement direction of the controlled character, the controlled character is controlled to move from the horizontal terrain object of the virtual scene to the vertical terrain object, that is, after entering the parkour movement state, when a vertical terrain object that meets the condition is detected, the controlled character can automatically move from the horizontal terrain object to the vertical terrain object. During the displacement process, the player does not need to perform other operations except the control of the movement direction, which effectively reduces the operation burden of player. At the same time, the terminal can also obtain, in response to the movement of the controlled character in a parkour movement state on the vertical surface of the vertical terrain object, the terrain data of the vertical surface, and control the controlled character to move along the vertical surface of the vertical terrain object with a movement action adapted to the terrain data. In addition to controlling the displacement changes of the controlled character on different terrain objects, when the movement action changes on the corresponding terrain object, the terminal can also control the controlled character to move on the corresponding terrain object based on the terrain data. The operational burden of the player is further reduced, the control method of the controlled character for the player is simplified, the player is enabled to focus more on other contents of the game and the immersion and other gaming experiences of player are enhanced.

In order to enable those skilled in the art to better understand the technical solutions in these embodiments of the present disclosure, some technical features involved in these embodiments of the present disclosure are explained and illustrated below.

Virtual scenes refer to scenes that are distinct from the real world and are outputted by devices. The virtual scenes can be visually perceived either with the naked eye or with the assistance of device, such as two-dimensional images output by display screen and three-dimensional images output by stereoscopic display technologies such as stereoscopic projection, virtual reality and augmented reality technology. Additionally, various senses that simulate the real world, such as auditory perception, tactile perception, olfactory perception and motion perception, can be formed through various possible hardware.

The “In response to” is used to indicate the conditions or states on which the executed operations depend. When the dependent conditions or states are met, one or more operations executed can be in real time or have a set delay. Unless otherwise specified, no restriction exists on the order of execution of the multiple operations.

A controlled character is an object that interacts in a virtual scene. The controlled character is controlled by a user or a robot program (for example, an artificial intelligence-based robot program) and can still, move, and be perform various behaviors in a virtual scene, such as various characters in a game.

Terrain objects can be the objects that make up the terrain of a game scene, include grasslands, plains, hills, mountains, forests, buildings, and the like. Specifically, terrain objects can also include obstacle objects located within the aforementioned terrain objects, such as boxes and stones on the ground. The terrain objects can be divided into horizontal terrain objects and vertical terrain objects. Horizontal terrain objects include terrain objects in which controlled characters move in a way that does not need to overcome gravity, such as hills, grasslands, plains and other horizontal or quasi-horizontal terrain. Vertical terrain objects include terrain objects in which the controlled character is to move in a specific way to overcome gravity, such as the vertical surface of mountains, trees, walls of buildings, and the like, and the controlled character is to perform corresponding actions (such as climbing) to realize the movement of horizontal terrain objects. For vertical terrain objects, the climbing animation performed by the controlled character involves hand movement (Inverse Kinematics), which drives corresponding shoulder motion. This process requires the terminal device to execute complex computations, resulting in significant performance overhead. Moreover, this simple climbing action has a slow-moving speed. When encountering complex terrain, it is necessary to control the controlled character to perform the corresponding action according to the judgment opportunity of player to pass through the corresponding terrain, which brings great operational burden to the player.

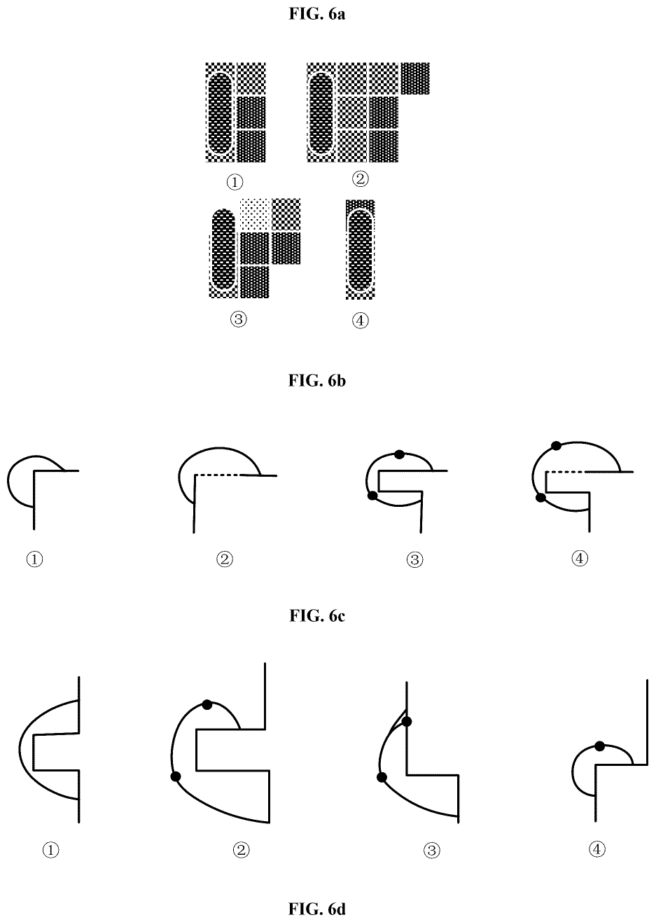

Referring to FIG. 5, a step flowchart of another method for controlling movement of a controlled character provided by an embodiment of the present disclosure is shown, where a graphical user interface is provided by an electronic terminal, the electronic terminal displays, by the graphical user interface, a virtual scene and a controlled character located in the virtual scene, following steps may be included.

In step 501, in response to an operation on the controlled character, a parkour movement state is entered, where, the parkour movement state is a state in which the controlled character is controlled, based on a terrain data, pass through a terrain object.

Optionally, the electronic terminal may include a mobile terminal and a PC terminal, and the like, and a game application may be stored in the local terminal device. It is non-standing that the terminal device may also be a cloud client, and the corresponding game functions may be provided in the game application. In these embodiments of the present disclosure, for illustrative explanation, the electronic terminal is a PC terminal, the player may control the controlled character through a mouse, keyboard, or game controller, and the like, and the present disclosure does not limit on this.

In step 502, in case that the controlled character is moving on a horizontal terrain object in the virtual scene in the parkour movement state, in response to an existence of a vertical terrain object meeting a preset climbing condition in a movement direction of the controlled character, the controlled character is controlled to move from the horizontal terrain object in the virtual scene to the vertical terrain object.

Optionally, in addition to the foregoing situation of entering the parkour movement state from the air and moving to the vertical terrain object from the air, when the controlled character moves on the horizontal terrain object of the virtual scene in the parkour movement state, the terminal can also detect the terrain in the movement direction of the controlled character. When it is detected that a vertical terrain object that meets the preset climbing conditions exists in the movement direction, the terminal can control the controlled character to move from the horizontal terrain object of the virtual scene to the vertical terrain object in response to the existence of the vertical terrain object that meets the preset climbing conditions in the movement direction of the controlled character, and then further perform terrain detection on the vertical surface of the vertical terrain object to control the controlled character to move on the vertical terrain object according to the corresponding terrain data.

In concrete implementation, the terminal can control, in response to the existence of the vertical terrain object within a preset distance threshold in the movement direction of the controlled character, and a height of the vertical terrain object being greater than or equal to a preset height threshold, the controlled character to move from the horizontal terrain object in the virtual scene to the vertical terrain object. After determining that the controlled character can move from the horizontal terrain object to the vertical terrain object, the terminal can obtain a posture tilt angle for jumping to the vertical terrain object in response to the controlled character moving to the second detection point of the horizontal terrain object. The second detection point is the jumping point from the horizontal terrain object to the vertical terrain object. Then, based on the relative distance between the second detection point and the vertical terrain object, and the posture tilt angle, the attachment point of the controlled character is determined from the vertical terrain object. Then, the controlled character is controlled to jump from the second detection point to the attachment point at the posture tilt angle. In this process, when the controlled character reaches the second detection point, the controlled character is still a certain distance away from the vertical terrain object. However, for the controlled character in the parkour movement state, the player does not need to control the controlled character to move from the horizontal terrain object to the vertical terrain object, but the terminal can directly “pull” the controlled character from the position of the second detection point to the attachment point on the vertical terrain object (including controlling the controlled character to jump up from the second detection point to the attachment point, fly from the second detection point to the attachment point, and the like), so as to realize automatic control of the controlled character from the horizontal terrain object to the vertical terrain object according to the terrain change, and automatically control the movement of the controlled character on different terrain objects through the terrain change, the control over the controlled character of player is simplified and the involvement in the movement of the controlled character in the virtual scene of player is enhanced. The posture tilt angle can be the angle at which the controlled character moves from the horizontal terrain object to the vertical terrain object in the corresponding movement direction. For example, when the posture tilt angle is 30 degrees, the controlled character can jump from the horizontal terrain object to the vertical terrain object in the movement direction with an angle of 30 degrees with the horizontal line.

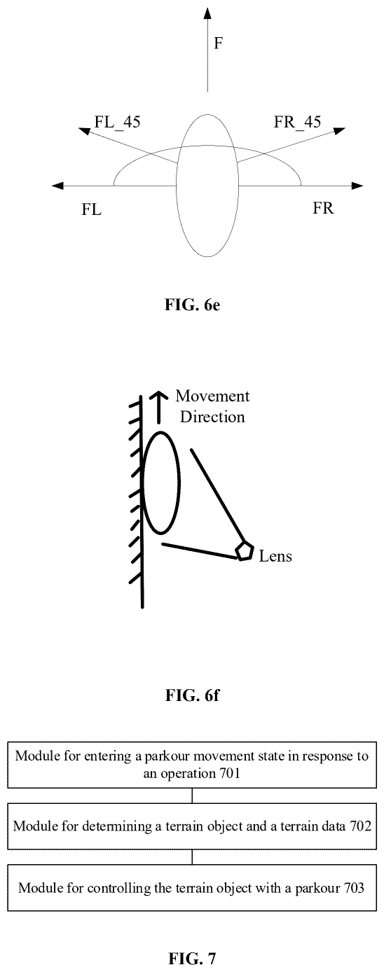

In one example, for the process of a controlled character moving from a horizontal terrain object to a vertical terrain object, the controlled character can move from the horizontal terrain object to the vertical terrain object through different movement directions (including left, right and front) (hereinafter referred to as a “wall climbing event”), and detect through the corresponding wall climbing node, so as to perform mapping selection according to the vertical surface of the vertical terrain object corresponding to the orientation of the controlled character. Specifically, for the “wall climbing event”, it may involve a wall detection node, a wall climbing node, an animation connection node, a speed control node, and an event node, and the like. Then, when the controlled character triggers the “wall climbing event” on the horizontal terrain object with Run/Rush, the terminal can detect the corresponding “wall climbing event” through the wall detection node, enter the wall climbing node of the “wall climbing” fusion tree, and play the animation corresponding to the wall climbing node. For the animation playing process, the wall climbing animation can be divided into two sections and selected and connected through the animation connection node. The first section is the wall climbing section, and the second section is the action stretching section. The speed control node controls the controlled character to “wall climbing” at a corresponding speed in the action stretching section to ensure that the controlled character can touch the vertical surface of the vertical terrain object at the position of climbing the wall. At the same time, the event node triggers the selection connection between the first section of the animation and the second section of the animation, and the second section of the animation can be controlled by a custom event to control the animation to transition to the vertical surface movement and stop climbing state, and the like, to indicate that the animation is to transition when it plays to the last frame. Referring to FIG. 6a, a schematic diagram of a moving scene provided in some embodiments of the present disclosure is shown. When a vertical terrain object that meets the climbing conditions is detected in the movement direction of the controlled character, by determining the corresponding detection point and attachment point, when the controlled character reaches the detection point A, the controlled character is triggered to jump from the detection point to the attachment point B with a preset posture tilt angle as the jumping direction, thereby realizing the movement of the controlled character from the horizontal terrain object to the vertical terrain object.

In addition, in the above process, when the controlled character enters the parkour movement state with Run/Rush and encounters a vertical terrain object during the movement, the camera is to automatically rotate to the back of the controlled character, but when the picture perspective encounters a vertical terrain object with a perspective facing the controlled character, the camera does not rotate, and the controlled character is to cross backwards and cannot move from the horizontal terrain object to the vertical terrain object.

In an optional embodiment, in addition to configuring the corresponding execution node to detect the vertical terrain object, the virtual scene can also be spatially divided, and a capsule corresponding to the controlled character and the divided virtual scene are compared and detected to determine whether a corresponding vertical terrain object exists in the movement direction of the controlled character. For example, if a corresponding spatial cube (that is, a cube corresponding to the vertical terrain object) within 2 meters exists in front of the capsule, and the height of the spatial cube is greater than or equal to the preset height threshold, it can be determined that a vertical terrain object that meets the climbing conditions exists in the movement direction of the controlled character. Referring to FIG. 6b, a schematic diagram of a capsule provided in some embodiments of the present disclosure is shown. The virtual scene is divided into different spatial cubes. FIG. 6b shows the game scene in cross-section. Each square can represent a spatial cube (unit cube, one unit is 1 meter), and the capsule (wrapped by a cuboid) can represent the position of the controlled character in the game scene. For \textcircled{1}, it represents that the controlled character is located on the vertical terrain object, and the thickness of the vertical terrain object is 1 meter; for \textcircled{2}, it represents that the controlled character is located on the vertical terrain object, and the longest distance between the vertical terrain object and the controlled character is 3 meters, and the shortest distance is 2 meters; for \textcircled{3}, it represents that the controlled character is located on the vertical terrain object, and the longest distance between the vertical terrain object and the controlled character is 2 meters, and the shortest distance is 1 meter; for \textcircled{4}, it only represents the controlled character, and as the terrain object changes, the positional relationship between the controlled character and the virtual scene can change accordingly. these embodiments of the present disclosure include but are not limited to the above examples. For terrain detection, the grid can be divided according to the requirements of long distance and low precision, and each grid can be judged on the wall to obtain the information of each grid along the wall up, down, left and right. The moving trajectory and state can be spelled out by the animation performance based on the terrain and the movement direction of the controlled character. The key position is obtained by the close-WO

range ray, and IK (Inverse Kinematics) adjusts the posture. Its connectivity in each direction can be configured as 6 connected directions, and the like, and its distance from the obstacle can be configured as 4 m. As an example, when performing space estimation, detection can be directed forward and upward, with a detection distance of 10 m, and can be scrolled and refreshed, and calculated in real time through rays. The capsule height can be configured to be 2 m, the upward detection distance can be configured to be 2.4 m, and the left and right detection distances can be configured to be 1.5 m.

When the controlled character reaches the vertical terrain object, the terminal can control, in response to the receiving of the movement control instruction for the virtual object, the controlled character to move on the vertical terrain object. It should be noted that the movement control instruction can be an instruction for controlling the movement direction of the controlled character. When the player stops inputting the movement control instruction, the terminal can control, in response to the end of the movement control instruction, the controlled character to stay on the vertical terrain object. In the parkour movement state, the terminal can remove the gravity of the controlled character in the virtual scene to control the controlled character to stay on the vertical terrain object, so that the controlled character can stay on the vertical terrain object in a similar “adsorption” manner.

In step 503, in response to the movement of the controlled character on a vertical surface of a vertical terrain object in the parkour movement state, a terrain data of the vertical surface is obtained; the controlled character is controlled to move along the vertical surface of the vertical terrain object with a movement action adapted to the terrain data.

When the controlled character moves on a vertical terrain object in a parkour movement state, the terminal can obtain the terrain data of the vertical surface of the vertical terrain object in real time by means of ray detection, and control the controlled character to move along the vertical surface of the vertical terrain object with a moving action adapted to the terrain data, that is, after entering the parkour movement state, when a vertical terrain object that meets the conditions is detected, the controlled character can automatically move from the horizontal terrain object to the vertical terrain object. During the displacement process, the player does not need to perform other operations except the movement direction control, the operating burden of player is effectively reduced. At the same time, the terminal can also obtain, in response to the movement of the controlled character in a parkour movement state on the vertical surface of the vertical terrain object, the terrain data of the vertical surface, and control the controlled character to move along the vertical surface of the vertical terrain object with a movement action adapted to the terrain data. In addition to controlling the displacement changes of the controlled character on different terrain objects, when the controlled character moving on the corresponding terrain object, the terminal can also control the movement action changes of the controlled character on the corresponding terrain object based on the terrain data. Not only the colorful changes of the movement actions of the controlled character following the terrain are realized, but also the game immersion of the player is improved. The operational burden of the player is further reduced, the control method of the controlled character for the player is simplified, the player is enabled to focus more on other contents of the game and the gaming experiences of player are enhanced.

Optionally, the movement of the controlled character on the vertical terrain object may include wall movement (Climb), wall climbing (ClimbToWall), wall descent (ClimbBackJump), and platform climbing (ClimbToPlatform), where Climb may be the controlled character moving (ClimbRun) and staying (ClimbIdel) on the vertical surface of the vertical terrain object, as well as some corresponding performance actions such as rolling and rotating when moving on the vertical surface; for ClimbToWall, it may be the process of climbing over an obstacle object protruding from the vertical surface of the vertical terrain object; for ClimbBackJump, it may be the process of moving from a vertical terrain object to a horizontal terrain object, that is, the process of jumping from a high place to a low place; for ClimbToPlatform, it can be the process of moving from the vertical surface of a vertical terrain object to the horizontal surface. The difference between ClimbToPlatform and ClimbToWall is that ClimbToWall corresponds to the convex obstacles on the vertical surface, after passing through the convex obstacles, the controlled character still is to move on the vertical surface, while ClimbToPlatform corresponds to the convex platforms corresponding to the horizontal surface of the vertical terrain object, including the inwardly concave platforms of the vertical terrain objects and the outwardly convex platforms. That is, the platform climbing can refer to the controlled character jumping to the concave area, or jumping onto the obstacle object.

For example, referring to FIG. 6c, a schematic diagram of a movement scene 1 provided in some embodiments of the present disclosure is shown (the movement scene is referred to as “ClimbToPlatform” below). For a scene in which a controlled character jumps from a vertical surface of a vertical terrain object to a platform (horizontal surface) of the vertical terrain object, the following steps are performed: \textcircled{1} executing a jumping action to directly jump from the vertical surface to the horizontal surface; \textcircled{2} a non-standing area exists on the horizontal surface, and when jumping, the character jumps from the vertical surface and crosses the non-standing area to reach a standing area on the horizontal surface; \textcircled{3} a convex platform exists on the horizontal surface relative to the vertical surface, and the character crosses the convex platform from the vertical surface and reaches the corresponding position of the horizontal surface; \textcircled{4} a non-standing area exists on the convex platform, and when jumping, the character jumps from the vertical surface to cross the convex platform to reach the standing area of the horizontal surface. In addition, the arcs in \textcircled{1}, \textcircled{2}, \textcircled{3} and \textcircled{4} represent the movement trajectory of the controlled character, the dotted line represents the non-standing area on the terrain object, and the dots represent multiple actions. Specifically, \textcircled{3} contains two dots, which means that the controlled character is to perform three actions in the process of moving from the vertical surface to the horizontal surface, such as the first jump up action, the second jump up action and the falling action, and the like. The same logic applies to \textcircled{4}, which will not be elaborated here. In addition, referring to FIG. 6d, a schematic diagram of the movement scene 2 provided in these embodiments of the present disclosure is shown (the movement scene 2 is referred to as “ClimbToWall” below), for the scene in which the controlled character moves on the vertical surface of the vertical terrain object, including \textcircled{1} for a relatively small convex obstacle on the vertical surface, a first jumping action is directly executed to cross the convex obstacle; \textcircled{2} for a relatively large convex obstacle on the vertical surface, at least one action is executed to cross the convex obstacle; \textcircled{3} another vertical surface area protruding relative to the current vertical surface area exists in the movement direction, a corresponding jumping action is executed to jump from the current vertical surface area to the vertical surface area; \textcircled{4} a concave area relative to the current vertical surface exists in the movement direction, a corresponding jumping action is executed to jump from the vertical surface to the concave area. It should be noted that with respect to the relevant meanings of arcs, dots, and the like, the above description can be referred to and will not be elaborated here.

Optionally, for the above process, for the different scenes involved in ClimbToWall and ClimbToPlatform, the terrain objects can be divided according to “convex” (i.e., obstacles) and “concave”. The “convex” can include the movement scenes corresponding to \textcircled{3} and \textcircled{4} of ClimbToPlatform and the movement scenes corresponding to \textcircled{1}, \textcircled{2}, and \textcircled{3} of ClimbToWall, while the “concave” can include the movement scenes corresponding to \textcircled{1} and \textcircled{2} of ClimbToPlatform and the movement scenes corresponding to \textcircled{4} of ClimbToWall. Then, according to the corresponding scenes, the terminal can control the controlled character to move on the vertical terrain object based on the terrain data obtained by real-time detection, with movement actions adapted to the terrain data.

In an optional embodiment, for a “concave” scene, the terminal can detect terrain data on the vertical surface in the movement direction of the controlled character in response to the vertical movement of the controlled character on the vertical surface of the vertical terrain object in a parkour move state. When the terrain data indicates that a concave area exists in the movement direction of the controlled character, the controlled character is controlled to perform a jumping action to reach the concave area.

In a specific implementation, if no non-standing area exists in the concave area, the terminal can control the controlled character to perform “one jumping action” or “one jumping action and one falling action” to control the controlled character to move from the vertical surface of the vertical terrain object to the horizontal surface. For example, for scene \textcircled{1} of ClimbToPlatform, the terminal can control the controlled character to perform a jumping action to move from the vertical surface of the vertical terrain object to the horizontal surface of the vertical terrain object (that is, the platform); for scene \textcircled{4} of ClimbToWall, the terminal can control the controlled character to perform a jumping up action and a falling action into the concave area to move from the vertical surface of the vertical terrain object to the horizontal surface.

If a non-standing area exists on the concave area, that is, when the terrain data represents that a concave area exists in the movement direction of the controlled character, the first jumping action to be performed by the controlled character is determined, and then the first landing point of the controlled character in the concave area can be determined according to the first jumping action. If the first landing point belongs to the non-standing area, the first jumping action is adjusted to a second jumping action that crosses the non-standing area, and then the controlled character is controlled to perform the second jumping action to reach the concave area. For example, for the \textcircled{2} scene of ClimbToPlatform, if a non-standing area exists, the first jumping action with a smaller jumping range is to be adjusted to a second jumping action that can cross the non-standing area, and then control the controlled character to perform the second jumping action to cross the non-standing area on the platform from the vertical surface of the vertical terrain object and reach the standing area of the concave area. In addition, for the \textcircled{4} scene of ClimbToWall, if a non-standing area exists, its processing process can refer to the \textcircled{2} scene of ClimbToPlatform, which will not be elaborated here.

In another optional embodiment, for the “convex” scene, the terminal can detect the terrain data of the vertical surface of the vertical terrain object in the movement direction of the controlled character. When the terrain data indicates that an obstacle object exists in the movement direction of the controlled character, a movement action for the controlled character to move onto or jump over the obstacle object based on a size parameter of the obstacle object is determined; the controlled character is controlled to move along the vertical surface based on the movement action. For the obstacle object, it can include the convex platform in the foregoing embodiments, and the size parameter can be a protruding width that represents the obstacle object relative to the vertical terrain object. Different protruding widths have different effects on the movement of the controlled character. Different “passing strategies” can be adopted for obstacle objects with different protruding widths, including passing through with different moving actions, and the like, and the present disclosure does not limit this.

In a specific implementation, if no non-standing area exists on the obstacle object, the terminal can determine that the controlled character is to perform at least one moving action based on the size parameter, so as to control the controlled character to cross the obstacle object and reach the corresponding position through the determined moving action. Specifically, if the size parameter of the obstacle object represents that the protruding width of the obstacle object relative to the vertical surface is less than a first preset threshold, then determine the jumping action for controlling the controlled character to jump from the first height of the vertical surface to the second height of the vertical surface to cross the obstacle object. The height at the first height is less than the height at the second height, and the obstacle object is located between the first height and the second height. If the size parameter of the obstacle object represents that the protruding width of the obstacle object relative to the vertical surface is greater than or equal to the first preset threshold, then determine that the moving action to be performed by the controlled character includes a back-off action away from the current vertical surface, a first jumping up action, and a first falling action falling onto the obstacle. Optionally, the first preset threshold can be a threshold set according to game requirements. For example, the first preset threshold can be set to 2 meters. Obstacle objects with a protruding width less than 2 meters can be determined as simple obstacle objects and can be passed through with a simple jumping action. Obstacle objects with a protruding width greater than 2 meters can be determined as complex obstacle objects and require multiple movement actions to cooperate in order to pass through.

If a non-standing area exists on the obstacle object, the terminal can determine the second landing point of the controlled character on the obstacle object based on the back-off action, the first jumping up action and the first falling action. If the second landing point belongs to the non-standing area, the first jumping up action is adjusted, and/or the first falling action is adjusted, and the standing area is determined on the obstacle object through the adjusted movement action. The adjustment of the first jumping up action and/or the first falling action can include: adjusting the first jumping up action to the second jumping up action, and/or adjusting the first falling action to the second falling action, and then the back-off action, the second jumping up action and the second falling action can be determined as the movement actions to be performed by the controlled character, or the back-off action, the second jumping up action and the first falling action are determined as the movement actions to be performed by the controlled character, or the back-off action, the second jumping up action and the first falling action are determined as the movement actions to be performed by the controlled character, or the back-off action, the first jumping up action and the second falling action are determined as the movement actions to be performed by the controlled character.

After determining the movement actions corresponding to different scenes based on the size parameters through the above process, the terminal can control the controlled character to move in the vertical surface according to the determined movement actions. For example, for scene \textcircled{1} of ClimbToWall, the terminal can control the controlled character to perform a jumping action to cross the obstacle object from the first height to the second height of the vertical terrain object.

For scene \textcircled{2} of ClimbToWall, the terminal can control the controlled character to perform a back-off action to jump to a first height in the air, then control the controlled character to perform a first jumping up action to jump from the first height in the air to a second height in the air, and then control the controlled character to perform a first falling action to fall from the second height in the air to the horizontal terrain object, where the first height is greater than or equal to the height corresponding to the lower horizontal surface of the obstacle object and less than the height corresponding to the upper horizontal surface of the obstacle object; the horizontal distance in the air at the first height relative to the vertical terrain object is greater than the protrusion width; the second height is greater than the height corresponding to the upper horizontal surface of the obstacle object. In addition, for this “passing strategy”, it is also applicable to scenes \textcircled{3} and \textcircled{4} of ClimbToPlatform. At the same time, it should be noted that, if an non-standing area exists on the convex obstacle or the convex platform, the terminal can adjust the first jumping up action to the second jumping up action, and/or adjust the first falling action to the second falling action, and then the back-off action, the second jumping up action and the second falling action can be determined as the movement actions to be performed by the controlled character, or the back-off action, the second jumping up action and the first falling action are determined as the movement actions to be performed by the controlled character, or the back-off action, the second jumping up action and the first falling action are determined as the movement actions to be performed by the controlled character, or the back-off action, the first jumping up action and the second falling action are determined as the movement actions to be performed by the controlled character. The jumping height of the second jumping up action is greater than that of the first jumping up action, and the falling distance of the second falling action is greater than that of the first falling action. Thus, by increasing the jumping height and/or falling distance of the controlled character, the controlled character can cross the non-standing area on the convex obstacle or convex platform.

In addition, for the \textcircled{3} scene of ClimbToWall, which involves the terrain changes between different vertical surface areas, the terminal can detect the vertical surface terrain data of the vertical terrain object in the movement direction of the controlled character, when the terrain data indicates that a second vertical surface area exists in the movement direction of the controlled character and the second vertical surface area protrudes relative to a first vertical surface area where the controlled character is currently located, the controlled character is controlled to perform a back-off action away from a currently located first vertical surface area and a jumping up action, to reach the second vertical surface area.

Optionally, the above process can be implemented based on the corresponding execution nodes and event configurations, which can be reflected in the game as playing the corresponding animations. For example, the four scene animations of Climb ToPlatform can be divided into two types: for scene \textcircled{1} of ClimbToPlatform, only the entire animation is to be played; for scene \textcircled{2} of ClimbToPlatform, a program is to be used to stretch the animation to a standing position. For scenes \textcircled{3} and \textcircled{4} of ClimbToPlatform, first of all, the controlled character is to be pulled out in the first section, then pulled up to the corresponding standing point, and then connected to the loop to land. Accordingly, after landing, the script is to be notified to switch actions, indicating whether it can be switched to landing Run (continue running in the movement direction after landing) or Idel (stay at the landing point after landing).

For ClimbBackJump, it can jump to the ground and then choose to stand on the ground or run on the ground. All of these are done by configuring the corresponding trigger event on the corresponding execution node and selecting the corresponding animation after the event is triggered.

For ClimbToWall, it is currently divided into two lengths and two groups of animations, a 0 m to 2 m obstacle small jumping and a 2 m to 4 m obstacle crossing. Specifically, for obstacles of 0 m to 2 m length, they are crossed by playing an animation and relying on displacement of the animation per se, instead of any displacement stretching; for obstacles of 2 m to 4 m, the animation is to be divided into three sections. For the convex parts, the 1 and 2 sections of the animation are played, and for the concave areas, sections 2-3 are played, first stretching the height, and then connecting the falling animation. For the 0 m to 2 m obstacle crossing, only an end transition is to be mounted. For the three-section animation of the 2 m to 4 m obstacle, the previous animation finally mounts the subActionEnd event (animation transition event) to transition, and the final landing animation notifies the script to transition.

In addition, the platform type can be determined through the detection node, and assigned to the animation selection node, and then selected. There are three animations that are selected sequentially by parameter control. For convex obstacles or convex platforms where there are non-standing areas, the controlled character can be controlled to move to the standing area by stretching, through the stretching node. For example, if the detection node detects that the obstacle object is the non-crossable type, that is, the convex platform, the “non-crossable type” is outputted, the corresponding three animations are obtained, and then the corresponding animations are played in sequence; if the obstacle object is the crossable type, that is, the convex obstacle, the “crossable type” is outputted, then the corresponding animations are obtained, and then the animations are played, so as to select the corresponding animation based on different types of obstacles, to present the process of the controlled character passing through the obstacle object through animation.

For scene \textcircled{1} in ClimbToWall, it does not need to be connected to the corresponding wall climbing animation. It can be configured into Climb to control the controlled character to perform the corresponding jumping action.

In the above embodiments, the process of the controlled character moving on the vertical terrain object based on the terrain data is covered. In addition, without encountering any obstacles or concave areas and other terrain, the terminal can respond to the movement of the controlled character on the vertical terrain object, and control the controlled character to perform one of the rotation actions or rolling actions during the movement. By controlling the controlled character to perform corresponding actions during the movement process, the corresponding actions are performed and corresponding action effects are added to improve the smoothness of the movement and the picture performance.

In the specific implementation, for the left, right, front and 45-degree directions of ClimbRun, the movement action is the same, and the corresponding action animation can be played in a loop. Only the footstep synchronization points are to be added. For the 180-degree turn animation, the left and right feet are selected by input selection nodes. At the end of the turn animation, add the ClimbChangeDir event (climbing change event) to force the climbing content of controlled character ClimbDir on the vertical terrain object to be modified. For ClimbIdel, only the left and right feet are to be considered and gravity is removed, without adding footstep synchronization. The stop step animation is to add footstep synchronization points, and the event StopActionEnd (stop animation event) is to be switched to switch the stop step to Idel. For some special performance actions, only ClimbSpecialEnd (climbing special action event) is to be added at the end of the animation to transition.

In one example, after the controlled character finishes playing the wall jumping animation, the controlled character enters the corresponding Idel/Run state machine (different staying states) according to the movement command input by the player. For Run, except for running forward on the vertical terrain object, other left, right and 45-degree running require BlendSpace2D blending (2D blending space), and the orientation selection node is used to select the orientation. For the selection of the left and right turning animation, the layer node is used to calculate the angle change between the previous and next frames and then select. The climbStop (climbing stop) let the near Idel select the stop animation branch. The specific logic of Idel is mainly to select a stop animation according to running, and then match the corresponding stop animation according to the stop animation. For the performance animation of random rolling and rotation on the vertical terrain object, considering the orientation problem, an orientation range selection can be made by first mapping for the orientation selection node, and then the corresponding ClimbBlender mixed value can be obtained by mapping for the value output by the orientation selection node, and the movement direction of the controlled character on the vertical terrain object is obtained by mixing the left and right and 45-degree actions. For example, referring to FIG. 6e, a schematic diagram of a movement direction fusion provided in these embodiments of the present disclosure is shown, where the direction directly in front of F is not mixed, that is, the movement direction and the action direction do not need to be mixed; FR is the right, and is mixed with FR_45 of 45 degrees, that is, when the movement direction is the right, the movement direction is mixed with the action direction of 45 degrees in front of the right, and the corresponding performance animation when the controlled character moves to the right is obtained; FL is the left, and is mixed with FL_45 of 45 degrees, that is, when the movement direction is the left, the movement direction is mixed with the action direction of 45 degrees in front of the left, and the corresponding performance animation when the controlled character moves to the left is obtained.

In addition, when the terrain data represents that a horizontal terrain object exists, such as the ground, in the movement direction of the controlled character, the controlled character is controlled to perform a falling action with uniform acceleration from the vertical terrain object to the horizontal terrain object, and in response to the controlled character moving from the vertical terrain object to the horizontal terrain object, when no obstacle object exists in the movement direction of the controlled character, the controlled character is controlled to perform a sprint action.

Optionally, these embodiments of the present disclosure can be applied to 3D games. During the game, the virtual scenes displayed on the terminal graphical user interface can be switched through the corresponding virtual camera. At the same time, the field of view mapped by the virtual camera in the graphical user interface can be controlled by controlling the focal length of the virtual camera. The larger the focal length, the smaller the field of view of the virtual scene presented in the graphical user interface, but the presented virtual scene can present more detailed game content to the player; the smaller the focal length, the larger the field of view, and a larger range of game scenes can be presented to the player in the graphical user interface. Correspondingly, the details of the game scene are reduced.

In a specific implementation, the terminal can increase the focal length of the virtual camera to reduce the field of view of the virtual camera in response to the controlled character moving on the vertical terrain object in a parkour move state, so as to achieve the enlargement of the virtual scene. Therefore, when the controlled character moves on the vertical terrain object in a parkour move state, the terminal can automatically adjust the focal length of the virtual camera to make the field of view of the virtual scene mapped to the graphical user interface smaller, thereby achieving the enlargement of the virtual scene, so that the player can intuitively perceive the details of the vertical terrain object where the controlled character is located, and it is convenient for the player to control the movement direction of the controlled character according to the perceived details, thereby effectively assisting the player in making decisions on game control.

Correspondingly, the terminal can also reduce the focal length of the virtual camera to increase the field of view of the virtual camera in response to the controlled character moving on the vertical terrain object in a parkour move state, so as to achieve the reduction of the virtual scene. By reducing the focal length, the terminal can present a virtual scene with a larger game field of view to the player in the graphical user interface, so that the player can perceive the terrain of the virtual scene through the larger game field of view, which makes it convenient for the player to control the movement direction of the controlled character according to the perceived content within the larger field of view, effectively assisting the player in making decisions on game control.

It should be noted that for the above two different scenes, they can be handled in opposite ways. In the actual game process, the focal length of a pair of virtual cameras can be adjusted according to the needs of the players, or one of them can be preset as the default adjustment solution. During the game, the player can also manually adjust the focal length of the virtual camera according to actual needs. The present disclosure does not limit on this.

In one example, in the process of controlling the controlled character to move from the horizontal terrain object to the vertical terrain object in the virtual scene, the virtual camera is controlled to move downward by a preset distance and face the back of the controlled character at a preset elevation angle. In a specific implementation, referring to FIG. 6f, a schematic diagram of the virtual camera adjustment provided in these embodiments of the present disclosure is shown. When the controlled character moves on the vertical terrain object, especially when moving upward, the terminal can control the virtual camera (i.e., the lens) to gradually move downward until a 45-degree upward visual angle of the back of the controlled character is reached. When the controlled character moves left and right, the virtual camera also rotates to the back of the controlled character. On the one hand, it can combine the characteristics of the game (such as the aerial agility in the martial arts, and the like) to present a good sense of picture to the player. On the other hand, by adjusting the visual angle, the player can better control the controlled character and the operating burden of player can be reduced.

In one example, the terminal may also obtain the orientation of the virtual camera in response to the movement of the controlled character on the vertical terrain object in a parkour move state, and if the virtual camera is facing the side of the controlled character, adjust the virtual camera to face the back of the controlled character.

In addition, when the player controls the controlled character to exit the parkour movement state, the terminal can adjust the virtual camera to a visual angle corresponding to the basic movement state in response to the controlled character staying on the vertical terrain object or exiting the parkour movement state.

Optionally, in the above process, when the controlled character moves in a parkour move state, key frame silhouettes can be performed, and the jumping form can be processed, so that when moving in a parkour move state, the controlled character has good smoothness and a corresponding sense of speed is created.

In these embodiments of the present disclosure, in the game application, for the controlled character controlled by the player, it can be configured with different basic movement states and parkour movement states. In the parkour movement state, the player can only control the movement direction of the controlled character, and for other actions of the controlled character passing through the terrain objects, the game application can automatically control the controlled character according to the terrain data in the virtual scene. Specifically, during the game process, the terminal can enter the parkour movement state in response to the operation on the controlled character. When the controlled character moves on the horizontal terrain object of the virtual scene in the parkour movement state, in response to the existence of a vertical terrain object that meets the preset climbing condition in the movement direction of the controlled character, the controlled character is controlled to move from the horizontal terrain object of the virtual scene to the vertical terrain object, that is, after entering the parkour movement state, when a vertical terrain object that meets the condition is detected, the controlled character can automatically move from the horizontal terrain object to the vertical terrain object. During the displacement process, other operations except the control of the movement direction performed by the player can be reduced, which effectively reduces the operation burden of player. At the same time, the terminal can also obtain, in response to the movement of the controlled character in a parkour movement state on the vertical surface of the vertical terrain object, the terrain data of the vertical surface, and control the controlled character to move along the vertical surface of the vertical terrain object with a movement action adapted to the terrain data. In addition to controlling the displacement changes of the controlled character on different terrain objects, when the controlled character moving on the corresponding terrain object, the terminal can also control, based on the terrain data, the movement action change of the movement of the controlled character on the corresponding terrain object. The operational burden of the player is further reduced, the control method of the controlled character for the player is simplified, the player is enabled to focus more on other contents of the game and the immersion and other gaming experiences of player are enhanced.

It should be noted that, for the method embodiments, for the sake of simplicity, they are all described as a series of action combinations, but those skilled in the art should be aware that these embodiments of the present disclosure are not limited by the order of the actions described, because according to these embodiments of the present disclosure, certain steps can be performed in other orders or simultaneously. Secondly, those skilled in the art should also be aware that these embodiments described in the specification are all preferred embodiments, and the actions involved are not necessarily required by these embodiments of the present disclosure.

Referring to FIG. 7, a structural block diagram of an apparatus for controlling movement of a controlled character provided by an embodiment of the present disclosure is shown, where a graphical user interface is provided by an electronic terminal, the electronic terminal displays, by the graphical user interface, a virtual scene and a controlled character located in the virtual scene.

Specifically, the following modules may be included:
a module for entering a parkour movement state in response to an operation 701, configured to enter, in response to an operation on the controlled character, a parkour movement state; where, the parkour movement state is a state in which the controlled character is controlled, based on a terrain data, to autonomously pass through a terrain object;
a module for determining a terrain object and a terrain data 702, configured to determine, in response to a movement of the controlled character in the virtual scene in the parkour movement state, a terrain object in the virtual scene and a terrain data of the terrain object; and
a module for controlling the terrain object with a parkour 703, configured to control the controlled character to autonomously pass through the terrain object with a parkour movement action adapted to the terrain data.

In one embodiment of the present disclosure, entering, in response to the operation on the controlled character, the parkour movement state includes: in case that the controlled character is moving on a horizontal terrain object in the virtual scene in a basic movement state, entering, in response to the operation on the controlled character, the parkour movement state; the basic movement state is a state in which the controlled character is controlled, based on an operation of players on the controlled character, to move; and controlling the controlled character to move on the horizontal terrain object or a vertical terrain object in the virtual scene in the parkour movement state.

In one embodiment of the present disclosure, entering, in response to the operation on the controlled character, the parkour movement state includes: in case that the controlled character is in air, entering, in response to the operation on the controlled character, the parkour movement state, and controlling the controlled character to perform a sprint action in a movement direction.

In one embodiment of the present disclosure, after the step of in case that the controlled character is in air, entering, in response to the operation on the controlled character, the parkour movement state, and controlling the controlled character to perform a sprint action in a movement direction, further including: in response to a process of the controlled character performing the sprint action and an existence of a vertical terrain object that meets a preset climbing condition in the movement direction, controlling the controlled character to move from the air to the vertical terrain object.

In one embodiment of the present disclosure, controlling the controlled character to move from the air to the vertical terrain object includes: controlling the controlled character to perform the sprint action and move to a first detection point corresponding to the vertical terrain object, where the first detection point is a jumping point for moving from the air to the vertical terrain object; and controlling the controlled character to perform a jumping action and move from the first detection point to the vertical terrain object, and controlling the controlled character to move along a vertical surface of the vertical terrain object.

In one embodiment of the present disclosure, determining, in response to a movement of the controlled character in the virtual scene in the parkour movement state, a terrain object in the virtual scene and a terrain data of the terrain object includes: obtaining, in response to the movement of the controlled character on a horizontal terrain object in the parkour movement state, a terrain data of the horizontal terrain object, where the horizontal terrain object is a ground object or a water surface object; the horizontal terrain object includes one or more obstacles; and controlling the controlled character to autonomously pass through above or along surfaces of the obstacles on the horizontal terrain object with parkour movement action adapted to the terrain data includes: controlling the controlled character to autonomously pass through above or along surfaces of the obstacles on the horizontal terrain object with the parkour movement action adapted to the terrain data.

In one embodiment of the present disclosure, controlling the controlled character to autonomously pass through above or along surfaces of the obstacles on the horizontal terrain object with the parkour movement action adapted to the terrain data includes: when the terrain data indicates that a first obstacle exists in a movement direction of the controlled character, determining a first size parameter of the first obstacle; and controlling the controlled character to pass through above or along a surface of the first obstacle with a parkour movement action adapted to the first size parameter.

In one embodiment of the present disclosure, the first size parameter further includes height information and width information of the first obstacle, and controlling the controlled character to pass through above or along the surface of the first obstacle with the parkour movement action adapted to the first size parameter includes: when the width information is less than a preset width threshold, controlling the controlled character to jump over the first obstacle with a jumping action adapted to the height information; and when the width information is greater than or equal to the preset width threshold, controlling the controlled character to jump onto the first obstacle from a surface of the horizontal terrain object with a jumping action adapted to the height information, and pass through the first obstacle along the surface of the first obstacle.

In one embodiment of the present disclosure, it is further configured to: during a jump process of the controlled character, when the controlled character reaches a first crossing position, enable a second forward detection along the movement direction of the controlled character to detect a second obstacle, where the first crossing position is a position on a crossing trajectory of the controlled character crossing the first obstacle; when the controlled character reaches a second crossing position, disable the first forward detection used for obtaining the terrain data, where the second crossing position is a position on the crossing trajectory before the first crossing position, and a detection distance of the first forward detection is greater than a detection distance of the second forward detection; when the controlled character reaches a third crossing position, disable the second forward detection and enable the first forward detection along the movement direction of the controlled character, where the third crossing position is a position, at a preset height in a falling stage, on the crossing trajectory after the first crossing position.

In one embodiment of the present disclosure, it is further configured to: if the controlled character detects a second obstacle in the movement direction of the controlled character after enabling the first forward detection at the third crossing position, determine a second size parameter of the second obstacle and control the controlled character to pass through above or along a surface of the second obstacle with a parkour movement action adapted to the second size parameter; if the controlled character detects the second obstacle after enabling the second forward detection at the first crossing position, control the controlled character to perform a sprint action in the movement direction, and move from air to a vertical terrain object formed by the second obstacle when the second obstacle meets a preset climbing condition.

In one embodiment of the present disclosure, it is further configured to: when the controlled character reaches a fourth crossing position, downward detect a current distance to ground of the controlled character, where the fourth crossing position is a position after a highest point on the crossing trajectory of the controlled character crossing the first obstacle; when the current distance to ground is detected as a second distance to ground, control the controlled character to perform a landing action.

In one embodiment of the present disclosure, controlling the controlled character to pass through above or along surfaces of the obstacles on the horizontal terrain object with the parkour movement action adapted to the terrain data includes: when the terrain data indicates that a first depression exists in a movement direction of the controlled character, determining the height information of a current position of the controlled character relative to the first depression; and controlling the controlled character to jump from the current position to the first depression according to a jumping action adapted to the height information.

In one embodiment of the present disclosure, determining, in response to a movement of the controlled character in the virtual scene in the parkour movement state, a terrain object in the virtual scene and a terrain data of the terrain object includes: in case that the controlled character is moving on a horizontal terrain object in the virtual scene in the parkour movement state, controlling, in response to an existence of a vertical terrain object meeting a preset climbing condition in a movement direction of the controlled character, the controlled character to move from the horizontal terrain object in the virtual scene to the vertical terrain object; and obtaining, in response to the movement of the controlled character on a vertical surface of a vertical terrain object in the parkour movement state, a terrain data of the vertical surface; and controlling the controlled character to autonomously pass through above or along surfaces of the obstacles on the horizontal terrain object with parkour movement action adapted to the terrain data includes: controlling the controlled character to move along the vertical surface of the vertical terrain object with a movement action adapted to the terrain data.

In one embodiment of the present disclosure, controlling the controlled character to move along the vertical surface of the vertical terrain object with a movement action adapted to the terrain data includes: when the terrain data indicates that a concave area exists in the movement direction of the controlled character, controlling the controlled character to perform a jumping action to reach the concave area.

In one embodiment of the present disclosure, controlling the controlled character to move along the vertical surface of the vertical terrain object with a movement action adapted to the terrain data includes: when the terrain data indicates that an obstacle object exists in the movement direction of the controlled character, determining a movement action for the controlled character to move onto or jump over the obstacle object based on a size parameter of the obstacle object; controlling the controlled character to move along the vertical surface based on the movement action.

In one embodiment of the present disclosure, controlling the controlled character to move along the vertical surface of the vertical terrain object with a movement action adapted to the terrain data includes: when the terrain data indicates that a second vertical surface area exists in the movement direction of the controlled character and the second vertical surface area protrudes relative to a first vertical surface area where the controlled character is currently located, controlling the controlled character to perform a back-off action away from a currently located first vertical surface area and a jumping up action, to reach the second vertical surface area.

In one embodiment of the present disclosure, controlling, in response to the existence of the vertical terrain object meeting the preset climbing condition in the movement direction of the controlled character, the controlled character to move from the horizontal terrain object in the virtual scene to the vertical terrain object includes: controlling, in response to the existence of the vertical terrain object within a preset distance threshold in the movement direction of the controlled character, and a height of the vertical terrain object being greater than or equal to a preset height threshold, the controlled character to move from the horizontal terrain object in the virtual scene to the vertical terrain object.

In one embodiment of the present disclosure, controlling the controlled character to move from the horizontal terrain object in the virtual scene to the vertical terrain object includes: obtaining, in response to the controlled character moving to a second detection point of the horizontal terrain object, a posture tilt angle for jumping to the vertical terrain object, where the second detection point is a jumping point from the horizontal terrain object to the vertical terrain object; determining, based on a relative distance between the second detection point and the vertical terrain object, and the posture tilt angle, an attachment point of the controlled character on the vertical terrain object; and controlling the controlled character to jump from the second detection point to the attachment point at the posture tilt angle.

In these embodiments of the present disclosure, in response to an operation on the controlled character, a parkour movement state is entered; where, the parkour movement state is a state in which the controlled character is controlled, based on a terrain data, to autonomously pass through a terrain object; in response to a movement of the controlled character in the virtual scene in the parkour movement state, a terrain object in the virtual scene and a terrain data of the terrain object are determined; and the controlled character is controlled to autonomously pass through terrain object with parkour movement action adapted to the terrain data. The controlled character can be controlled to move automatically by adopting the parkour movement action adapted to the terrain data, so that the controlled character can adapt to different terrain conditions and can obtain a faster moving speed, and the smoothness of the controlled character in open world exploration is improved.

An embodiment of the present disclosure also provides an electronic device, be including a processor, a memory, and a computer program stored on the memory and capable of running on the processor, when the computer program is executed by the processor, the following steps of the foregoing method for controlling the movement of the controlled character are implemented.

In response to an operation on the controlled character, a parkour movement state is entered; where, the parkour movement state is a state in which the controlled character is controlled, based on a terrain data, to autonomously pass through a terrain object.

In response to a movement of the controlled character in the virtual scene in the parkour movement state, a terrain object in the virtual scene and a terrain data of the terrain object are determined.

The controlled character is controlled to autonomously pass through terrain object with parkour movement action adapted to the terrain data.

Optionally, entering, in response to the operation on the controlled character, the parkour movement state can be implemented by the following steps: in case that the controlled character is moving on a horizontal terrain object in the virtual scene in a basic movement state, entering, in response to the operation on the controlled character, the parkour movement state; the basic movement state is a state in which the controlled character is controlled, based on an operation of players on the controlled character, to move; and controlling the controlled character to move on the horizontal terrain object or a vertical terrain object in the virtual scene in the parkour movement state.

Optionally, entering, in response to the operation on the controlled character, the parkour movement state can be implemented by the following steps: in case that the controlled character is in air, entering, in response to the operation on the controlled character, the parkour movement state, and controlling the controlled character to perform a sprint action in a movement direction.

Optionally, after the step of in case that the controlled character is in air, entering, in response to the operation on the controlled character, the parkour movement state, and controlling the controlled character to perform a sprint action in a movement direction, the following steps may be further performed: in response to a process of the controlled character performing the sprint action and an existence of a vertical terrain object that meets a preset climbing condition in the movement direction, controlling the controlled character to move from the air to the vertical terrain object.

Optionally, controlling the controlled character to move from the air to the vertical terrain object can be implemented by the following steps: controlling the controlled character to perform the sprint action and move to a first detection point corresponding to the vertical terrain object, where the first detection point is a jumping point for moving from the air to the vertical terrain object; and controlling the controlled character to perform a jumping action and move from the first detection point to the vertical terrain object, and controlling the controlled character to move along a vertical surface of the vertical terrain object.

Optionally, determining, in response to a movement of the controlled character in the virtual scene in the parkour movement state, a terrain object in the virtual scene and a terrain data of the terrain object can be implemented by the following steps: obtaining, in response to the movement of the controlled character on a horizontal terrain object in the parkour movement state, a terrain data of the horizontal terrain object, where the horizontal terrain object is a ground object or a water surface object; the horizontal terrain object includes one or more obstacles; and controlling the controlled character to autonomously pass through above or along surfaces of the obstacles on the horizontal terrain object with parkour movement action adapted to the terrain data includes: controlling the controlled character to autonomously pass through above or along surfaces of the obstacles on the horizontal terrain object with the parkour movement action adapted to the terrain data.

Optionally, controlling the controlled character to autonomously pass through above or along surfaces of the obstacles on the horizontal terrain object with the parkour movement action adapted to the terrain data can be implemented by the following steps: when the terrain data indicates that a first obstacle exists in a movement direction of the controlled character, determining a first size parameter of the first obstacle; and controlling the controlled character to pass through above or along a surface of the first obstacle with a parkour movement action adapted to the first size parameter.

Optionally, the first size parameter further includes height information and width information of the first obstacle, and controlling the controlled character to pass through above or along the surface of the first obstacle with the parkour movement action adapted to the first size parameter can be implemented by the following steps: when the width information is less than a preset width threshold, controlling the controlled character to jump over the first obstacle with a jumping action adapted to the height information; and when the width information is greater than or equal to the preset width threshold, controlling the controlled character to jump onto the first obstacle from a surface of the horizontal terrain object with a jumping action adapted to the height information, and pass through the first obstacle along the surface of the first obstacle.

Optionally, the following steps may be further performed: during a jump process of the controlled character, when the controlled character reaches a first crossing position, enabling a second forward detection along the movement direction of the controlled character to detect a second obstacle, where the first crossing position is a position on a crossing trajectory of the controlled character crossing the first obstacle; when the controlled character reaches a second crossing position, disabling the first forward detection used for obtaining the terrain data, where the second crossing position is a position on the crossing trajectory before the first crossing position, and a detection distance of the first forward detection is greater than a detection distance of the second forward detection; when the controlled character reaches a third crossing position, disabling the second forward detection and enabling the first forward detection along the movement direction of the controlled character, where the third crossing position is a position, at a preset height in a falling stage, on the crossing trajectory after the first crossing position.

Optionally, the following steps may be further performed: if the controlled character detects a second obstacle in the movement direction of the controlled character after enabling the first forward detection at the third crossing position, determining a second size parameter of the second obstacle and control the controlled character to pass through above or along a surface of the second obstacle with a parkour movement action adapted to the second size parameter; if the controlled character detects the second obstacle after enabling the second forward detection at the first crossing position, controlling the controlled character to perform a sprint action in the movement direction, and move from air to a vertical terrain object formed by the second obstacle when the second obstacle meets a preset climbing condition.

Optionally, the following steps may be further performed: when the controlled character reaches a fourth crossing position, downward detecting a current distance to ground of the controlled character, where the fourth crossing position is a position after a highest point on the crossing trajectory of the controlled character crossing the first obstacle; when the current distance to ground is detected as a second distance to ground, controlling the controlled character to perform a landing action.

Optionally, controlling the controlled character to pass through above or along surfaces of the obstacles on the horizontal terrain object with the parkour movement action adapted to the terrain data can be implemented by the following steps: when the terrain data indicates that a first depression exists in a movement direction of the controlled character, determining the height information of a current position of the controlled character relative to the first depression; and controlling the controlled character to jump from the current position to the first depression according to a jumping action adapted to the height information.

Optionally, determining, in response to a movement of the controlled character in the virtual scene in the parkour movement state, a terrain object in the virtual scene and a terrain data of the terrain object can be implemented by the following steps: in case that the controlled character is moving on a horizontal terrain object in the virtual scene in the parkour movement state, controlling, in response to an existence of a vertical terrain object meeting a preset climbing condition in a movement direction of the controlled character, the controlled character to move from the horizontal terrain object in the virtual scene to the vertical terrain object; and obtaining, in response to the movement of the controlled character on a vertical surface of a vertical terrain object in the parkour movement state, a terrain data of the vertical surface; and controlling the controlled character to autonomously pass through above or along surfaces of the obstacles on the horizontal terrain object with parkour movement action adapted to the terrain data can be implemented by the following steps: controlling the controlled character to move along the vertical surface of the vertical terrain object with a movement action adapted to the terrain data.

Optionally, controlling the controlled character to move along the vertical surface of the vertical terrain object with a movement action adapted to the terrain data can be implemented by the following steps: when the terrain data indicates that a concave area exists in the movement direction of the controlled character, controlling the controlled character to perform a jumping action to reach the concave area.

Optionally, controlling the controlled character to move along the vertical surface of the vertical terrain object with a movement action adapted to the terrain data can be implemented by the following steps: when the terrain data indicates that an obstacle object exists in the movement direction of the controlled character, determining a movement action for the controlled character to move onto or jump over the obstacle object based on a size parameter of the obstacle object; controlling the controlled character to move along the vertical surface based on the movement action.

Optionally, controlling the controlled character to move along the vertical surface of the vertical terrain object with a movement action adapted to the terrain data can be implemented by the following steps: when the terrain data indicates that a second vertical surface area exists in the movement direction of the controlled character and the second vertical surface area protrudes relative to a first vertical surface area where the controlled character is currently located, controlling the controlled character to perform a back-off action away from a currently located first vertical surface area and a jumping up action, to reach the second vertical surface area.

Optionally, controlling, in response to the existence of the vertical terrain object meeting the preset climbing condition in the movement direction of the controlled character, the controlled character to move from the horizontal terrain object in the virtual scene to the vertical terrain object can be implemented by the following steps: controlling, in response to the existence of the vertical terrain object within a preset distance threshold in the movement direction of the controlled character, and a height of the vertical terrain object being greater than or equal to a preset height threshold, the controlled character to move from the horizontal terrain object in the virtual scene to the vertical terrain object.

Optionally, controlling the controlled character to move from the horizontal terrain object in the virtual scene to the vertical terrain object can be implemented by the following steps: obtaining, in response to the controlled character moving to a second detection point of the horizontal terrain object, a posture tilt angle for jumping to the vertical terrain object, where the second detection point is a jumping point from the horizontal terrain object to the vertical terrain object; determining, based on a relative distance between the second detection point and the vertical terrain object, and the posture tilt angle, an attachment point of the controlled character on the vertical terrain object; and controlling the controlled character to jump from the second detection point to the attachment point at the posture tilt angle.

In response to an operation on the controlled character, a parkour movement state is entered; where, the parkour movement state is a state in which the controlled character is controlled, based on a terrain data, to autonomously pass through a terrain object; in response to a movement of the controlled character in the virtual scene in the parkour movement state, a terrain object in the virtual scene and a terrain data of the terrain object are determined; and the controlled character is controlled to autonomously pass through terrain object with parkour movement action adapted to the terrain data. The controlled character can be controlled to move automatically by adopting the parkour movement action adapted to the terrain data, so that the controlled character can adapt to different terrain conditions and can obtain a faster moving speed, and the smoothness of the controlled character in open world exploration is improved.

An embodiment of the present disclosure also provides a computer-readable storage medium, where the computer-readable storage medium stores a computer program, and when the computer program is executed by a processor, the processor implements the following steps of the foregoing method for controlling the movement of the controlled character.

In response to an operation on the controlled character, a parkour movement state is entered; where, the parkour movement state is a state in which the controlled character is controlled, based on a terrain data, to autonomously pass through a terrain object.

In response to a movement of the controlled character in the virtual scene in the parkour movement state, a terrain object in the virtual scene and a terrain data of the terrain object are determined.

The controlled character is controlled to autonomously pass through terrain object with parkour movement action adapted to the terrain data.

Optionally, entering, in response to the operation on the controlled character, the parkour movement state can be implemented by the following steps: in case that the controlled character is moving on a horizontal terrain object in the virtual scene in a basic movement state, entering, in response to the operation on the controlled character, the parkour movement state; the basic movement state is a state in which the controlled character is controlled, based on an operation of players on the controlled character, to move; and controlling the controlled character to move on the horizontal terrain object or a vertical terrain object in the virtual scene in the parkour movement state.

Optionally, entering, in response to the operation on the controlled character, the parkour movement state can be implemented by the following steps: in case that the controlled character is in air, entering, in response to the operation on the controlled character, the parkour movement state, and controlling the controlled character to perform a sprint action in a movement direction.

Optionally, after the step of in case that the controlled character is in air, entering, in response to the operation on the controlled character, the parkour movement state, and controlling the controlled character to perform a sprint action in a movement direction, the following steps may be further performed: in response to a process of the controlled character performing the sprint action and an existence of a vertical terrain object that meets a preset climbing condition in the movement direction, controlling the controlled character to move from the air to the vertical terrain object.

Optionally, controlling the controlled character to move from the air to the vertical terrain object can be implemented by the following steps: controlling the controlled character to perform the sprint action and move to a first detection point corresponding to the vertical terrain object, where the first detection point is a jumping point for moving from the air to the vertical terrain object; and controlling the controlled character to perform a jumping action and move from the first detection point to the vertical terrain object, and controlling the controlled character to move along a vertical surface of the vertical terrain object.

Optionally, determining, in response to a movement of the controlled character in the virtual scene in the parkour movement state, a terrain object in the virtual scene and a terrain data of the terrain object can be implemented by the following steps: obtaining, in response to the movement of the controlled character on a horizontal terrain object in the parkour movement state, a terrain data of the horizontal terrain object, where the horizontal terrain object is a ground object or a water surface object; the horizontal terrain object includes one or more obstacles; and controlling the controlled character to autonomously pass through above or along surfaces of the obstacles on the horizontal terrain object with parkour movement action adapted to the terrain data includes: controlling the controlled character to autonomously pass through above or along surfaces of the obstacles on the horizontal terrain object with the parkour movement action adapted to the terrain data.

Optionally, controlling the controlled character to autonomously pass through above or along surfaces of the obstacles on the horizontal terrain object with the parkour movement action adapted to the terrain data can be implemented by the following steps: when the terrain data indicates that a first obstacle exists in a movement direction of the controlled character, determining a first size parameter of the first obstacle; and controlling the controlled character to pass through above or along a surface of the first obstacle with a parkour movement action adapted to the first size parameter.

Optionally, the first size parameter further includes height information and width information of the first obstacle, and controlling the controlled character to pass through above or along the surface of the first obstacle with the parkour movement action adapted to the first size parameter can be implemented by the following steps: when the width information is less than a preset width threshold, controlling the controlled character to jump over the first obstacle with a jumping action adapted to the height information; and when the width information is greater than or equal to the preset width threshold, controlling the controlled character to jump onto the first obstacle from a surface of the horizontal terrain object with a jumping action adapted to the height information, and pass through the first obstacle along the surface of the first obstacle.

Optionally, the following steps may be further performed: during a jump process of the controlled character, when the controlled character reaches a first crossing position, enabling a second forward detection along the movement direction of the controlled character to detect a second obstacle, where the first crossing position is a position on a crossing trajectory of the controlled character crossing the first obstacle; when the controlled character reaches a second crossing position, disabling the first forward detection used for obtaining the terrain data, where the second crossing position is a position on the crossing trajectory before the first crossing position, and a detection distance of the first forward detection is greater than a detection distance of the second forward detection; when the controlled character reaches a third crossing position, disabling the second forward detection and enabling the first forward detection along the movement direction of the controlled character, where the third crossing position is a position, at a preset height in a falling stage, on the crossing trajectory after the first crossing position.

Optionally, the following steps may be further performed: if the controlled character detects a second obstacle in the movement direction of the controlled character after enabling the first forward detection at the third crossing position, determining a second size parameter of the second obstacle and control the controlled character to pass through above or along a surface of the second obstacle with a parkour movement action adapted to the second size parameter; if the controlled character detects the second obstacle after enabling the second forward detection at the first crossing position, controlling the controlled character to perform a sprint action in the movement direction, and move from air to a vertical terrain object formed by the second obstacle when the second obstacle meets a preset climbing condition.

Optionally, the following steps may be further performed: when the controlled character reaches a fourth crossing position, downward detect a current distance to ground of the controlled character, where the fourth crossing position is a position after a highest point on the crossing trajectory of the controlled character crossing the first obstacle; when the current distance to ground is detected as a second distance to ground, controlling the controlled character to perform a landing action.

Optionally, controlling the controlled character to pass through above or along surfaces of the obstacles on the horizontal terrain object with the parkour movement action adapted to the terrain data can be implemented by the following steps: when the terrain data indicates that a first depression exists in a movement direction of the controlled character, determining the height information of a current position of the controlled character relative to the first depression; and controlling the controlled character to jump from the current position to the first depression according to a jumping action adapted to the height information.

Optionally, determining, in response to a movement of the controlled character in the virtual scene in the parkour movement state, a terrain object in the virtual scene and a terrain data of the terrain object can be implemented by the following steps: in case that the controlled character is moving on a horizontal terrain object in the virtual scene in the parkour movement state, controlling, in response to an existence of a vertical terrain object meeting a preset climbing condition in a movement direction of the controlled character, the controlled character to move from the horizontal terrain object in the virtual scene to the vertical terrain object; and obtaining, in response to the movement of the controlled character on a vertical surface of a vertical terrain object in the parkour movement state, a terrain data of the vertical surface; and controlling the controlled character to autonomously pass through above or along surfaces of the obstacles on the horizontal terrain object with parkour movement action adapted to the terrain data can be implemented by the following steps: controlling the controlled character to move along the vertical surface of the vertical terrain object with a movement action adapted to the terrain data.

Optionally, controlling the controlled character to move along the vertical surface of the vertical terrain object with a movement action adapted to the terrain data can be implemented by the following steps: when the terrain data indicates that a concave area exists in the movement direction of the controlled character, controlling the controlled character to perform a jumping action to reach the concave area.

Optionally, controlling the controlled character to move along the vertical surface of the vertical terrain object with a movement action adapted to the terrain data can be implemented by the following steps: when the terrain data indicates that an obstacle object exists in the movement direction of the controlled character, determining a movement action for the controlled character to move onto or jump over the obstacle object based on a size parameter of the obstacle object; controlling the controlled character to move along the vertical surface based on the movement action.

Optionally, controlling the controlled character to move along the vertical surface of the vertical terrain object with a movement action adapted to the terrain data can be implemented by the following steps: when the terrain data indicates that a second vertical surface area exists in the movement direction of the controlled character and the second vertical surface area protrudes relative to a first vertical surface area where the controlled character is currently located, controlling the controlled character to perform a back-off action away from a currently located first vertical surface area and a jumping up action, to reach the second vertical surface area.

Optionally, controlling, in response to the existence of the vertical terrain object meeting the preset climbing condition in the movement direction of the controlled character, the controlled character to move from the horizontal terrain object in the virtual scene to the vertical terrain object can be implemented by the following steps: controlling, in response to the existence of the vertical terrain object within a preset distance threshold in the movement direction of the controlled character, and a height of the vertical terrain object being greater than or equal to a preset height threshold, the controlled character to move from the horizontal terrain object in the virtual scene to the vertical terrain object.

Optionally, controlling the controlled character to move from the horizontal terrain object in the virtual scene to the vertical terrain object can be implemented by the following steps: obtaining, in response to the controlled character moving to a second detection point of the horizontal terrain object, a posture tilt angle for jumping to the vertical terrain object, where the second detection point is a jumping point from the horizontal terrain object to the vertical terrain object; determining, based on a relative distance between the second detection point and the vertical terrain object, and the posture tilt angle, an attachment point of the controlled character on the vertical terrain object; and controlling the controlled character to jump from the second detection point to the attachment point at the posture tilt angle.

In response to an operation on the controlled character, a parkour movement state is entered; where, the parkour movement state is a state in which the controlled character is controlled, based on a terrain data, to autonomously pass through a terrain object; in response to a movement of the controlled character in the virtual scene in the parkour movement state, a terrain object in the virtual scene and a terrain data of the terrain object are determined; and the controlled character is controlled to autonomously pass through terrain object with parkour movement action adapted to the terrain data. The controlled character can be controlled to move automatically by adopting the parkour movement action adapted to the terrain data, so that the controlled character can adapt to different terrain conditions and can obtain a faster moving speed, and the smoothness of the controlled character in open world exploration is improved.

As for the apparatus embodiment, since it is basically similar to the method embodiment, the description is relatively simple, and the relevant parts can be referred to the partial description of the method embodiment.

It should be noted that the user information (including but not limited to user device information, user personal information, and the like) and data (including but not limited to data used for analysis, stored data, displayed data, and the like) involved in the present disclosure are all information and data authorized by the user or fully authorized by all parties, and the collection, use and processing of relevant data must comply with the relevant laws, regulations and standards of relevant countries and regions, and corresponding operation entrances is provided for users to choose to authorize or refuse.

The various embodiments in this specification are described in a progressive manner, and each embodiment focuses on the differences from other embodiments. The same or similar parts between the various embodiments can be referred to each other.

Those skilled in the art should know that these embodiments of the present disclosure may be provided as methods, devices, or computer program products. Therefore, these embodiments of the present disclosure may take the form of a complete hardware embodiment, a complete software embodiment, or an embodiment combining software and hardware. Furthermore, these embodiments of the present disclosure may take the form of a computer program product implemented on one or more computer-usable storage media (including but not limited to disk storage, CD-ROM, optical storage, and the like) containing computer-usable program code.

These embodiments of the present disclosure are described with reference to the flowcharts and/or block diagrams of the methods, terminal devices (systems), and computer program products according to these embodiments of the present disclosure. It should be understood that each process and/or box in the flowchart and/or block diagram, as well as the combination of the processes and/or boxes in the flowchart and/or block diagram, can be implemented by computer program instructions. These computer program instructions can be provided to a processor of a general-purpose computer, a special-purpose computer, an embedded processor, or other programmable data processing terminal device to generate a machine, so that the instructions executed by the processor of the computer or other programmable data processing terminal device generate a device for implementing the functions specified in one or more processes in the flowchart and/or one or more boxes in the block diagram.

These computer program instructions may also be stored in a computer-readable memory that can direct a computer or other programmable data processing terminal device to operate in a specific manner, so that the instructions stored in the computer-readable memory produce a manufactured product including an instruction device that implements the functions specified in one or more processes in the flowchart and/or one or more boxes in the block diagram.

These computer program instructions can also be loaded onto a computer or other programmable data processing terminal device so that a series of operating steps are executed on the computer or other programmable terminal device to produce computer-implemented processing, so that the instructions executed on the computer or other programmable terminal device provide steps for implementing the functions specified in one or more processes in the flowchart and/or one or more boxes in the block diagram.

Although the preferred embodiments of the present disclosure have been described, those skilled in the art may make additional changes and modifications to these embodiments once they have learned the basic creative concept. Therefore, the appended claims are intended to be interpreted as including the preferred embodiments and all changes and modifications that fall within the scope of the present disclosure.

Finally, it should be noted that, in this article, relational terms such as first and second, and the like are only used to distinguish one entity or operation from another entity or operation, and do not necessarily require or imply any such actual relationship or order between these entities or operations. Moreover, the terms “include”, “comprise” or any other variants thereof are intended to cover non-exclusive inclusion, so that a process, method, article or terminal device including a series of elements includes not only those elements, but also other elements not explicitly listed, or also includes elements inherent to such process, method, article or terminal device. In the absence of further restrictions, the elements defined by the sentence “including one . . . ” do not exclude the existence of other identical elements in the process, method, article or terminal device including the above elements.

The above is a detailed introduction to the provided a method, an apparatus, a device and a medium for controlling the movement of a controlled character. Specific examples are used in this article to illustrate the principles and implementation methods of the present disclosure. The description of the above embodiments is only used to help understand the method of the present disclosure and the core idea. At the same time, for those skilled in the art, according to the idea of the present disclosure, there will be changes in the specific implementation methods and application scope. In summary, the content of this specification should not be understood as a limitation on the present disclosure.

1. A method for controlling a movement of a controlled character, wherein a graphical user interface is provided by an electronic terminal, the electronic terminal displays, by the graphical user interface, a virtual scene and the controlled character located in the virtual scene, and the method comprises:
activating, in response to an operation on the controlled character, a parkour movement state; wherein, the parkour movement state is a state in which the controlled character is controlled, based on a terrain data, to pass through a terrain object;
determining, in response to a movement of the controlled character in the virtual scene in the parkour movement state, the terrain object in the virtual scene and a terrain data of the terrain object; and
controlling the controlled character to pass through the terrain object with a parkour movement action adapted to the terrain data.

2. The method according to claim 1, wherein activating, in response to the operation on the controlled character, the parkour movement state comprises:
in response to the controlled character moving on a horizontal terrain object in the virtual scene in a basic movement state, activating, in response to the operation on the controlled character, the parkour movement state; the basic movement state is a state in which the controlled character is controlled, based on an operation of players on the controlled character, to move; and
controlling the controlled character to move on the horizontal terrain object or a vertical terrain object in the virtual scene in the parkour movement state.

3. The method according to claim 1, wherein activating, in response to the operation on the controlled character, the parkour movement state comprises:
in response to the controlled character being in air, activating, in response to the operation on the controlled character, the parkour movement state, and controlling the controlled character to perform a sprint action in a movement direction.

4. The method according to claim 3, further comprising:
in response to a process of the controlled character performing the sprint action and an existence of a vertical terrain object that meets a preset climbing condition in the movement direction, controlling the controlled character to move from the air to the vertical terrain object.

5. The method according to claim 4, wherein controlling the controlled character to move from the air to the vertical terrain object comprises:
controlling the controlled character to perform the sprint action and move to a first detection point corresponding to the vertical terrain object, wherein the first detection point is a jumping point for moving from the air to the vertical terrain object; and
controlling the controlled character to perform a jumping action and move from the first detection point to the vertical terrain object, and controlling the controlled character to move along a vertical surface of the vertical terrain object.

6. The method according to claim 1, wherein determining, in response to the movement of the controlled character in the virtual scene in the parkour movement state, the terrain object in the virtual scene and the terrain data of the terrain object comprises:
obtaining, in response to the movement of the controlled character on a horizontal terrain object in the parkour movement state, a terrain data of the horizontal terrain object, wherein the horizontal terrain object is a ground object or a water surface object; the horizontal terrain object comprises one or more obstacles;
controlling the controlled character to pass through the terrain object with the parkour movement action adapted to the terrain data comprises:
controlling the controlled character to pass through above or along surfaces of the obstacles on the horizontal terrain object with the parkour movement action adapted to the terrain data.

7. The method according to claim 6, wherein controlling the controlled character to pass through above or along the surfaces of the obstacles on the horizontal terrain object with the parkour movement action adapted to the terrain data comprises:
in response to the terrain data indicating that a first obstacle exists in a movement direction of the controlled character, determining a first size parameter of the first obstacle; and controlling the controlled character to pass through above or along a surface of the first obstacle with a parkour movement action adapted to the first size parameter.

8. The method according to claim 7, wherein the first size parameter further comprises height information and width information of the first obstacle, and controlling the controlled character to pass through above or along the surface of the first obstacle with the parkour movement action adapted to the first size parameter comprises:
in response to the width information being less than a preset width threshold, controlling the controlled character to jump over the first obstacle with a jumping action adapted to the height information;
in response to the width information being greater than or equal to the preset width threshold, controlling the controlled character to jump onto the first obstacle from a surface of the horizontal terrain object with a jumping action adapted to the height information, and pass through the first obstacle along the surface of the first obstacle.

9. The method according to claim 8, further comprising:
during a jump process of the controlled character, in response to the controlled character reaching a first crossing position, enabling a second forward detection along the movement direction of the controlled character to detect a second obstacle, wherein the first crossing position is a position on a crossing trajectory of the controlled character crossing the first obstacle;
in response to the controlled character reaching a second crossing position, disabling the first forward detection used for obtaining the terrain data, wherein the second crossing position is a position on the crossing trajectory before the first crossing position, and a detection distance of the first forward detection is greater than a detection distance of the second forward detection;
in response to the controlled character reaching a third crossing position, disabling the second forward detection and enabling the first forward detection along the movement direction of the controlled character, wherein the third crossing position is a position, at a preset height in a falling stage, on the crossing trajectory after the first crossing position.

10. The method according to claim 9, further comprising:
in response to detecting a second obstacle in the movement direction of the controlled character after enabling the first forward detection at the third crossing position, determining a second size parameter of the second obstacle and controlling the controlled character to pass through above or along a surface of the second obstacle with a parkour movement action adapted to the second size parameter;
if in response to detecting the second obstacle after enabling the second forward detection at the first crossing position, controlling the controlled character to perform a sprint action in the movement direction, and move, when the second obstacle meets a preset climbing condition, from air to a vertical terrain object formed by the second obstacle.

11. The method according to claim 8, further comprising:
in response to the controlled character reaching a fourth crossing position, downward detecting a current distance to ground of the controlled character, wherein the fourth crossing position is a position after a highest point on the crossing trajectory of the controlled character crossing the first obstacle;
in response to the current distance to ground being detected as a second distance to ground, controlling the controlled character to perform a landing action.

12. The method according to claim 6, wherein controlling the controlled character to pass through above or along the surfaces of the obstacles on the horizontal terrain object with the parkour movement action adapted to the terrain data comprises:
in response to the terrain data indicating that a first depression exists in a movement direction of the controlled character, determining height information of a current position of the controlled character relative to the first depression; and
controlling the controlled character to jump from the current position to the first depression according to a jumping action adapted to the height information.

13. The method according to claim 1, wherein determining, in response to the movement of the controlled character in the virtual scene in the parkour movement state, the terrain object in the virtual scene and the terrain data of the terrain object comprises:
in case that the controlled character is moving on a horizontal terrain object in the virtual scene in the parkour movement state, controlling, in response to an existence of a vertical terrain object meeting a preset climbing condition in a movement direction of the controlled character, the controlled character to move from the horizontal terrain object in the virtual scene to the vertical terrain object; and
obtaining, in response to the movement of the controlled character on a vertical surface of a vertical terrain object in the parkour movement state, a terrain data of the vertical surface;
controlling the controlled character to pass through the terrain object with the parkour movement action adapted to the terrain data comprises:
controlling the controlled character to move along the vertical surface of the vertical terrain object with a movement action adapted to the terrain data.

14. The method according to claim 13, wherein controlling the controlled character to move along the vertical surface of the vertical terrain object with the movement action adapted to the terrain data comprises:
in response to the terrain data indicating that a concave area exists in the movement direction of the controlled character, controlling the controlled character to perform a jumping action to reach the concave area.

15. The method according to claim 13, wherein controlling the controlled character to move along the vertical surface of the vertical terrain object with the movement action adapted to the terrain data comprises:
in response to the terrain data indicating that an obstacle object exists in the movement direction of the controlled character, determining a movement action for the controlled character to move onto or jump over the obstacle object based on a size parameter of the obstacle object;
controlling the controlled character to move along the vertical surface based on the movement action.

16. The method according to claim 13, wherein controlling the controlled character to move along the vertical surface of the vertical terrain object with the movement action adapted to the terrain data comprises:
in response to the terrain data indicating that a second vertical surface area exists in the movement direction of the controlled character and the second vertical surface area protrudes relative to a first vertical surface area where the controlled character is currently located, controlling the controlled character to perform a back-off action away from a currently located first vertical surface area and a jumping up action, to reach the second vertical surface area.

17. The method according to claim 13, wherein controlling, in response to the existence of the vertical terrain object meeting the preset climbing condition in the movement direction of the controlled character, the controlled character to move from the horizontal terrain object in the virtual scene to the vertical terrain object comprises:
controlling, in response to the existence of the vertical terrain object within a preset distance threshold in the movement direction of the controlled character, and a height of the vertical terrain object being greater than or equal to a preset height threshold, the controlled character to move from the horizontal terrain object in the virtual scene to the vertical terrain object.

18. The method according to claim 17, wherein controlling the controlled character to move from the horizontal terrain object in the virtual scene to the vertical terrain object comprises:
obtaining, in response to the controlled character moving to a second detection point of the horizontal terrain object, a posture tilt angle for jumping to the vertical terrain object, wherein the second detection point is a jumping point from the horizontal terrain object to the vertical terrain object.
determining, based on a relative distance between the second detection point and the vertical terrain object, and the posture tilt angle, an attachment point of the controlled character on the vertical terrain object;
controlling the controlled character to jump from the second detection point to the attachment point at the posture tilt angle.

19. (canceled)

20. An electronic device, comprising a processor, a memory, and a computer program stored on the memory and capable of running on the processor, wherein the processor, through executing the computer program, is configured to:
activate, in response to an operation on a controlled character, a parkour movement state; wherein a graphical user interface is provided by the electronic device for displaying a virtual scene and the controlled character located in the virtual scene, and the parkour movement state is a state in which the controlled character is controlled, based on a terrain data, to pass through a terrain object;
determine, in response to a movement of the controlled character in the virtual scene in the parkour movement state, the terrain object in the virtual scene and a terrain data of the terrain object; and
control the controlled character to pass through the terrain object with a parkour movement action adapted to the terrain data.

21. A non-transitory computer-readable storage medium, wherein the computer-readable storage medium stores a computer program, and when the computer program is executed by a processor, the processor implements a method for controlling a movement of a controlled character, wherein the method comprises:
activating, in response to an operation on the controlled character, a parkour movement state; wherein a graphical user interface is provided by the electronic device for displaying a virtual scene and the controlled character located in the virtual scene, and the parkour movement state is a state in which the controlled character is controlled, based on a terrain data, to pass through a terrain object;
determining, in response to a movement of the controlled character in the virtual scene in the parkour movement state, the terrain object in the virtual scene and a terrain data of the terrain object; and
controlling the controlled character to pass through the terrain object with a parkour movement action adapted to the terrain data.
